(19) United States
(12) Patent Application Publication
(10) Pub. No.: US 2026/0320556 A1
(43) Pub. Date: Oct. 15, 2026

(54) SHOPPING INFORMATION PROVIDING METHOD AND REFRIGERATOR USING SAME

(71) Applicant: Samsung Electronics Co., Ltd., Suwon-si (KR)

(72) Inventors: Jieun LEE, Suwon-si (KR); Kyoungha SHIN, Suwon-si (KR); Jeehwan PARK, Suwon-si (KR); Hyelim PARK, Suwon-si (KR); Soohyun SUNG, Suwon-si (KR); Byeongcheol YOON, Suwon-si (KR); Seulgi LEE, Suwon-si (KR); Chihong CHO, Suwon-si (KR)

(21) Appl. No.: 19/703,796

(22) Filed: Jun. 10, 2026

Related U.S. Application Data
(63) Continuation of application No. PCT/KR2024/015926, filed on Oct. 18, 2024.

(30) Foreign Application Priority Data
Dec. 15, 2023 (KR) 10-2023-0182950
Jan. 31, 2024 (KR) 10-2024-0015192

(51) Int. Cl. G06Q 10/087; G06Q 30/0601; H04N 7/18

(52) U.S. Cl. CPC G06Q 10/08774; G06Q 30/0633; H04N 7/188

(57) ABSTRACT

A shopping information providing method and a refrigerator using the method are provided. The method includes identifying a category of displayed food items on a display stand in front of which a user is located in a store, generating shopping information related to stored food items included in the identified category among one or more food items stored in a refrigerator, and transmitting the generated shopping information to a user terminal, wherein the shopping information includes at least one of a list of the stored food items, locations of the stored food items, an internal image displaying the stored food items, a required list requiring purchase in the category, recipe information related to the displayed food items and the stored food items, and recommended storage location information related to where the displayed food items are to be stored in the refrigerator.

### CROSS-REFERENCE TO RELATED APPLICATION(S)

This application is a continuation application, claiming priority under 35 U.S.C. § 365(c), of an International application No. PCT/KR2024/015926, filed on Oct. 18, 2024, which is based on and claims the benefit of a Korean patent application number 10-2023-0182950, filed on Dec. 15, 2023, in the Ministry of Intellectual Property (MOIP), and of a Korean patent application number 10-2024-0015192, filed on Jan. 31, 2024, in the Ministry of Intellectual Property (MOIP), the disclosure of each of which is incorporated by reference herein in its entirety

### BACKGROUND

### 1. Field

The disclosure relates to a method for providing shopping information and a refrigerator using the method. More particularly, the disclosure relates to a technology for providing a user terminal with shopping information based on food information of a refrigerator when a user enters a store to shop for food.

### 2. Description of Related Art

With the development of Internet of things (IoT) technology, home appliances, such as refrigerators may be used by being connected to a user terminal through wireless communication. A refrigerator may provide information related to food items stored in the refrigerator to the user terminal.

In addition, the user terminal may register an area including a specific location, such as a house. When a current location of the user terminal enters the area, the user terminal may request the home appliances to provide information. The home appliances may provide information related to the home appliances to the user terminal. For example, when the user terminal enters the area, the refrigerator may provide the user terminal with the information related to the food items stored in the refrigerator.

However, in an existing method, the user needs to register the area in advance, and when the user is outside the registered area, the existing method may not be used. For example, when the user is shopping for food items outside the registered area, the user is unable to receive the information related to the food items from the refrigerator.

In addition, because the existing method provides the information only based on whether the user has entered the area regardless of whether the user currently intends to shop for food items and whether the user is about to buy necessary food items, shopping efficiency of the user may deteriorate.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for providing shopping information and a refrigerator using the method.

Additional aspects will be set forth in part in the description which follows and, in part, will be apparent from the description, or may be learned by practice of the presented embodiments.

In accordance with an aspect of the disclosure, a method of providing shopping information is provided. The method includes identifying a category of food items for sale in a store, generating shopping information related to stored food items included in the identified category from among at least one food item stored in a refrigerator, and transmitting the generated shopping information to the user terminal, wherein the shopping information includes at least one of a list of the stored food items, locations of the stored food items, an internal image of the refrigerator displaying the stored food items, a requirement list requiring purchase in the category, recipe information related to the food items for sale and the stored food items, and recommended storage location information related to where the food items for sale are to be stored in the refrigerator.

In accordance with an aspect of the disclosure, a refrigerator is provided. The refrigerator includes a communication module, at least one camera, memory, including one or more storage media, storing instructions, and at least one processor communicatively coupled to the communication module, the at least one camera, and the memory, wherein the instructions, when executed by the at least one processor individually or collectively, cause the refrigerator to receive, from a user terminal, a result of identifying a category of food items for sale in a store, generate shopping information related to stored food items included in the identified category from among at least one stored food item, and transmit the generated shopping information to the user terminal, and wherein the shopping information includes at least one of a list of the stored food items, locations of the stored food items, an internal image of the refrigerator displaying the stored food items, a requirement list requiring purchase in the category, recipe information related to the food items for sale and the stored food items, and recommended storage location information related to where the food items for sale are to be stored in the refrigerator.

In accordance with an aspect of the disclosure, one or more non-transitory computer-readable storage media storing one or more computer programs including computer-executable instructions that, when executed by at least one processor of a refrigerator, cause the refrigerator to perform operations are provided. The operations include receiving a result of identifying a category of food items for sale in a store, generating shopping information related to stored food items included in the identified category from among at least one food item stored in the refrigerator, and transmitting the generated shopping information to the user terminal, wherein the shopping information includes at least one of a list of the stored food items, locations of the stored food items, an internal image of the refrigerator displaying the stored food items, a requirement list requiring purchase in the category, recipe information related to the food items for sale and the stored food items, and recommended storage location information related to where the food items for sale are to be stored in the refrigerator.

Other aspects, advantages, and salient features of the disclosure will become apparent to those skilled in the art from the following detailed description, which, taken in conjunction with the annexed drawings, discloses various embodiments of the disclosure

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a system for implementing a method of providing shopping information, according to an embodiment of the disclosure;

FIG. 2 is a diagram illustrating an external structure of a refrigerator according to an embodiment of the disclosure;

FIG. 3 is a diagram illustrating an internal structure of a refrigerator according to an embodiment of the disclosure;

FIG. 4 is a flowchart illustrating a method of providing shopping information according to an embodiment of the disclosure;

FIG. 5 is a diagram illustrating a refrigerator displaying food information about food items stored in the refrigerator according to an embodiment of the disclosure;

FIG. 6 is a diagram illustrating a refrigerator displaying food information about food items stored in the refrigerator according to an embodiment of the disclosure;

FIG. 7 is a diagram illustrating a refrigerator displaying an in/out record of food items stocked in and taken out of the refrigerator according to an embodiment of the disclosure;

FIG. 8 is a flowchart illustrating a method of identifying a category of food items displayed in a store to provide shopping information according to an embodiment of the disclosure;

FIG. 9 is a diagram illustrating obtaining store information based on map information to identify a category according to an embodiment of the disclosure;

FIG. 10 is a diagram illustrating obtaining store information based on map information to identify a category according to an embodiment of the disclosure;

FIG. 11 is a diagram illustrating obtaining display stand information based on indoor information to identify a category according to an embodiment of the disclosure;

FIG. 12 is a diagram illustrating identifying a category based on a display image captured by a user terminal according to an embodiment of the disclosure;

FIG. 13 is a flowchart illustrating a method of obtaining information related to food items included in an identified category to provide shopping information according to an embodiment of the disclosure;

FIG. 14A is a diagram illustrating outputting of an internal image corresponding to a category to provide shopping information according to an embodiment of the disclosure;

FIG. 14B is a diagram illustrating outputting of an internal image corresponding to a category to provide shopping information according to an embodiment of the disclosure;

FIG. 15 is a diagram illustrating an internal image corresponding to a category according to an embodiment of the disclosure;

FIG. 16 is a diagram illustrating outputting of storage list information and requirement list information corresponding to a category to provide shopping information according to an embodiment of the disclosure;

FIG. 17 is a diagram illustrating outputting of recipe information corresponding to a category to provide shopping information according to an embodiment of the disclosure;

FIG. 18 is a diagram illustrating outputting of a recommended storage location of a displayed food item to provide shopping information according to an embodiment of the disclosure;

FIG. 19 is a diagram illustrating a user interface (UI) of a case where a category of a food item is not identified when entering a store, to provide shopping information, according to an embodiment of the disclosure;

FIG. 20 is a diagram illustrating a UI of a case where a category of a food item is identified when entering a store, to provide shopping information, according to an embodiment of the disclosure;

FIG. 21 is a diagram illustrating a UI of a case where a category of a food item is identified according to a user input, to provide shopping information, according to an embodiment of the disclosure; and

FIG. 22 is a diagram illustrating a UI of a case where an individual food item is identified according to a user input, to provide shopping information, according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, each of the phrases “A or B”, “at least one of A and B”, “at least one of A or B”, “A, B, or C”, “at least one of A, B, and C”, and “at least one of A, B, or C” may include one of the items listed together in the phrase or all possible combinations of the items.

The term “and/or” includes a combination of a plurality of related components or one component from among the plurality of related components.

The terms, such as “first” and “second” may be used to distinguish one component from another component, and do not limit the components in another aspect (e.g., importance or order).

In addition, the terms, such as “front surface”, “rear surface”, “upper surface”, “lower surface”, “side surface”, “left side”, “right side”, “upper portion”, and “lower portion” used in the disclosure are defined based on the drawings, and a shape and position of each component are not limited by these terms.

The terms, such as “including” or “having”, etc., are intended to indicate the existence of the features, numbers, steps, actions, components, parts, or combinations thereof described in the disclosure, and are not intended to preclude the possibility that one or more other features, numbers, steps, actions, components, parts, or combinations thereof may exist or may be added.

When a component is “connected,” “coupled,” “supported,” or “in contact with” another component, not only the components are directly connected, coupled, supported, or in contact with each other, but also the components are indirectly connected, coupled, supported, or in contact with each other through a third component.

When a component is “on” another component, not only the component is in contact with the other component, but also an intervening component may be present between the two components.

A refrigerator according to an embodiment may include a main body.

The “main body” may include an inner case, an outer case arranged outside the inner case, and an insulator provided between the inner case and the outer case.

The “inner case” may include at least one of a case, a plate, a panel, or a liner forming a storage compartment. The inner case may be formed as one body or may be formed by assembling a plurality of plates. The “outer case” may form an exterior of the main body, and may be combined to an outer side of the inner case such that the insulator is arranged between the inner case and the outer case.

The “insulator” may insulate the inside and outside of the storage compartment such that a temperature inside the storage compartment may be maintained at a set appropriate temperature without being affected by an environment outside the storage compartment. According to an embodiment of the disclosure, the insulator may include a foam insulator. The foam insulator may be molded by injecting and foaming urethane foam, in which polyurethane and a foaming agent are mixed, between the inner case and the outer case.

According to an embodiment of the disclosure, the insulator may include a vacuum insulator in addition to the foam insulator, or the insulator may include only the vacuum insulator instead of the foam insulator. The vacuum insulator may include a core material and an outer skin material that accommodates the core material and seals the inside thereof with a vacuum or a pressure close to a vacuum. However, the insulator is not limited to the foam insulator or the vacuum insulator, and may include any material that may be used for insulation.

The “storage compartment” may include a space defined by the inner case. The storage compartment may further include an inner case defining a space corresponding to the storage compartment. Various articles, such as food items, drugs, and cosmetics may be stored in the storage compartment, and the storage compartment may have at least one side open such that the articles may be put in or taken out.

The refrigerator may include one or more storage compartments. When two or more storage compartments are included in the refrigerator, the respective storage compartments may have different uses and may be maintained at different temperatures. To this end, the storage compartments may be partitioned from each other by a partition wall including an insulator.

The storage compartment may be provided to be maintained in an appropriate temperature range according to a use, and may include a “fridge compartment”, a “freezer compartment”, or a “temperature-changing compartment” divided according to a use and/or a temperature range. The fridge compartment may be maintained at a temperature suitable for refrigerating and storing an article, and the freezer compartment may be maintained at a temperature suitable for freezing and storing an article. “Refrigeration” may refer to cooling down an article within a limit in which the article is not frozen, and for example, the fridge compartment may be maintained in a range of 0 °C to 7 °C. “Freezing” may refer to freezing an article or cooling down the article so as to keep the article frozen, and for example, the freezer compartment may be maintained in a range of −20 °C. to −1 °C. The temperature-changing compartment may be used as one of the fridge compartment and the freezer compartment according to a user's selection or regardless thereof.

The storage compartment may be referred to as various names, such as “vegetable compartment”, “fresh compartment”, “cooling compartment”, and “ice making compartment” in addition to the names of “fridge compartment”, “freezer compartment”, and “temperature-changing compartment”, and the terms “fridge compartment”, “freezer compartment”, and “temperature-changing compartment” used below should be understood as encompassing storage compartments having corresponding uses and temperature ranges, respectively.

According to an embodiment of the disclosure, the refrigerator may include at least one door configured to open or close one open side of the storage compartment. The door may be provided to open or close each of one or more storage compartments, or one door may be provided to open or close a plurality of storage compartments. The door may be rotatably or slidably installed on a front surface of the main body.

The “door” may be configured to seal the storage compartment when the door is closed. The door may include an insulator like the main body so as to insulate the storage compartment when the door is closed.

According to an embodiment of the disclosure, the door may include a door outer plate forming a front surface of the door, a door inner plate forming a rear surface of the door and facing the storage compartment, an upper cap, a lower cap, and a door insulator provided therein.

A gasket may be provided at an edge of the door inner plate to seal the storage compartment by being adhered to a front surface of the main body when the door is closed. The door inner plate may include a dyke protruding backwards so that a door basket capable of storing an article is mounted thereon.

According to an embodiment of the disclosure, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulator provided therein.

The refrigerator may be classified as a French door type, a side-by-side type, a bottom mounted freezer (BMF), a top mounted freezer (TMF), or a one-door refrigerator, according to arrangements of the door and the storage compartment.

According to an embodiment of the disclosure, the refrigerator may include a cold air supply device provided to supply cold air to the storage compartment.

The “cold air supply device” may include a machine, an apparatus, an electronic device, and/or a system in which the above components are combined, which may generate cold air and guide the cold air to cool down the storage compartment.

According to an embodiment of the disclosure, the cold air supply device may generate cold air through a refrigeration cycle including compression, condensation, expansion, and evaporation processes of a refrigerant. To this end, the cold air supply device may include a refrigeration cycle device including a compressor, a condenser, an expansion device, and an evaporator capable of driving the refrigeration cycle. According to an embodiment of the disclosure, the cold air supply device may include a semiconductor, such as a thermoelectric element. The thermoelectric element may cool down the storage compartment by a heating and cooling action through a Peltier effect.

According to an embodiment of the disclosure, the refrigerator may include a machinery room in which at least some components belonging to the cold air supply device are arranged.

The “machinery room” may be provided to be partitioned and insulated from the storage compartment to prevent heat generated from the components arranged in the machinery room from being transferred to the storage compartment. The inside of the machinery room may be configured to communicate with the outside of the main body to dissipate heat from the components arranged inside the machinery room.

According to an embodiment of the disclosure, the refrigerator may include a dispenser provided on the door to provide water and/or ice. The dispenser may be provided on the door so that the user may access the dispenser without opening the door.

According to an embodiment of the disclosure, the refrigerator may include an ice making device provided to generate ice. The ice making device may include an ice making tray for storing water, an ice separating device for separating ice from the ice making tray, and an ice bucket for storing ice generated in the ice making tray.

According to an embodiment of the disclosure, the refrigerator may include a controller for controlling the refrigerator.

The “controller” may include memory storing or memorizing a program and/or data for controlling the refrigerator, and a processor configured to output a control signal for controlling the cold air supply device or the like according to the program and/or data stored in the memory.

The memory stores or records various types of information, data, instructions, programs, or the like necessary for operations of the refrigerator. The memory may store temporary data generated while a control signal for controlling the components included in the refrigerator is generated. The memory may include at least one of volatile memory or non-volatile memory, or a combination thereof.

The processor controls overall operations of the refrigerator. The processor may control the components of the refrigerator by executing the program stored in the memory. The processor may include a separate neural processing unit (NPU) that performs operations of an artificial intelligence model. In addition, the processor may include a central processing unit, a graphics dedicated processor (GPU), or the like. The processor may generate a control signal for controlling an operation of the cold air supply device. For example, the processor may receive temperature information of the storage compartment from a temperature sensor, and generate a cooling control signal for controlling an operation of the cold air supply device, based on the temperature information of the storage compartment.

In addition, the processor may process a user input of a user interface according to a program and/or data memorized/stored in the memory, and control an operation of the user interface. The user interface may be provided using an input interface and an output interface. The processor may receive the user input from the user interface. In addition, the processor may transmit a display control signal for displaying an image on the user interface, and image data to the user interface in response to the user input.

The processor and the memory may be provided integrally or separately. The processor may include one or more processors. For example, the processor may include a main processor and at least one sub-processor. The memory may include one or more memories.

According to an embodiment of the disclosure, the refrigerator may include a processor and memory that control all components included in the refrigerator, and may include a plurality of processors and a plurality of memories that individually control the components of the refrigerator. For example, the refrigerator may include a processor and memory that control an operation of the cold air supply device according to an output of the temperature sensor. In addition, the refrigerator may separately include a processor and memory for controlling an operation of the user interface according to a user input.

A communication module may communicate with an external device, such as a server, a mobile device, or another home appliance, through a nearby access point (AP). The AP may connect a local area network (LAN) to which the refrigerator or a user device is connected to a wide area network (WAN) to which a server is connected. The refrigerator or the user device may be connected to the server through the WAN.

The input interface may include a key, a touch screen, a microphone, or the like. The input interface may receive a user input and transmit the user input to the processor.

The output interface may include a display, a speaker, or the like. The output interface may output various notifications, messages, information, or the like generated by the processor.

A method of providing shopping information and a system for implementing the method, according to the disclosure, are to display the shopping information through a mobile device, based on food information of a refrigerator when a user enters a store for grocery shopping.

Hereinafter, the method for providing shopping information and the system for implementing the method, according to the disclosure, will be described with reference to the accompanying drawings.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

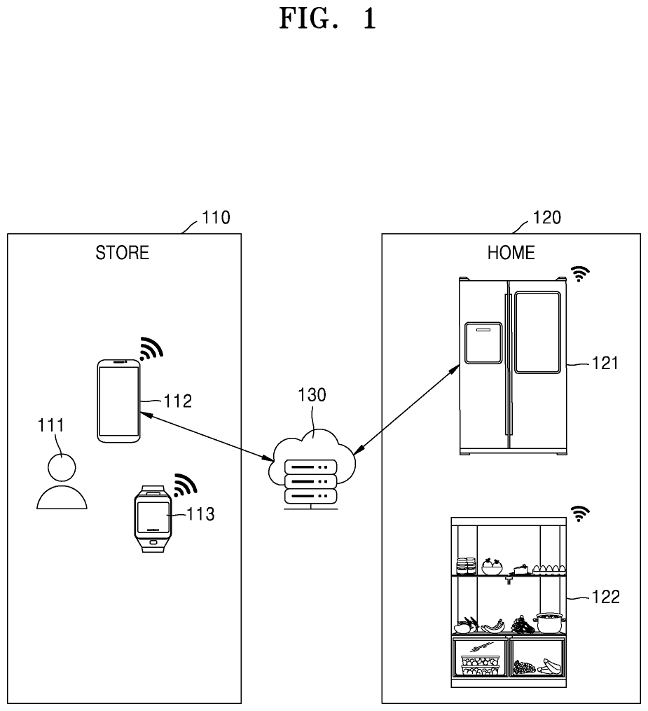

FIG. 1 is a diagram illustrating a system for implementing a method of providing shopping information according to an embodiment of the disclosure.

Referring to FIG. 1, the system according to an embodiment may include user terminals 112 and 113 carried by a user 111 located in a store 110, refrigerators 121 and 122 located at home 120, and a server 130.

The store 110 may be a place where the user 111 intends to purchase food items. For example, the store 110 may be at least one of a food store, a supermarket, a butcher shop, and a mart.

The user terminals 112 and 113 may be electronic devices carried by the user 111. For example, the user terminals 112 and 113 may include a smartphone. However, the disclosure is not limited thereto, and the user terminals 112 and 113 may include a smart watch. Hereinafter, for convenience of description, reference numerals of the user terminals 112 and 113 may be referred to as a user terminal 112.

The user terminal 112 may communicate with the server 130 or the refrigerators 121 and 122 to receive food information about food items stored in the refrigerators 121 and 122. The user terminal 112 may recognize that the user has entered the store 110 by using location information (a global positioning system (GPS)).

When a beacon for location recognition is installed in the store 110, the user terminal 112 may recognize a display stand or a corner where the user is located, based on a signal received from the beacon. For example, the beacon may be a wireless communication AP, an optical signal transceiver, or an acoustic signal transceiver. The user terminal 112 may identify a category of food items displayed on the display stand or the corner, based on the recognized display stand or the recognized corner.

The user terminal 112 may recognize an image in the store 110 to identify the category of the food items. The user terminal 112 may recognize product codes of the food items to identify the category of the food items. For example, the product code of the food item may be a quick response (QR) code or a barcode printed on a packaging of the food item. The user terminal 112 may receive a user input to identify the category of the food items.

The refrigerators 121 and 122 may be home appliances for storing food items. The refrigerators 121 and 122 may be a smart refrigerator 121 or a smart pantry. Hereinafter, for convenience of description, reference numerals of the refrigerators 121 and 122 may be referred to as a refrigerator 121.

The refrigerator 121 may recognize stored food items or in/out of the food items. The refrigerator 121 may generate food information including a list of stored food items and an in/out record. The refrigerator 121 may be connected to the server 130 and the user terminal 112 through wireless communication. The refrigerator 121 may transmit the food information to the server 130. The refrigerator 121 may transmit the food information to the user terminal 112 through the server 130.

The server 130 may be an Internet of things (IoT) server. The server 130 may connect the refrigerator 121 and the user terminal 112 to each other through wireless communication. The server 130 may transmit information related to the category of food items identified by the user terminal 112 to the refrigerator 121. The server 130 may transmit the food information transmitted from the refrigerator 121 to the user terminal 112. The server 130 may store the food information received from the refrigerator 121. For example, the server 130 may receive an internal image of the refrigerator 121 from the refrigerator 121 and store the same.

The server 130 of the disclosure may be an operation subject providing the shopping information to the user terminal 112, based on the food information received from the refrigerator 121. The server 130 may generate the shopping information requested by the user terminal 112 by using the stored food information. For example, the server 130 may generate the shopping information of the category related to the food items identified by the user terminal 112 by using the stored internal image. The server 130 may transmit the generated shopping information to the user terminal 112.

The server 130 may request the refrigerator 121 for information required to generate the shopping information requested by the user terminal 112. For example, when the server 130 requires a current internal image of the refrigerator 121 to generate the shopping information, the server 130 may request the refrigerator 121 to provide the internal image of the refrigerator 121 in real time. The server 130 may receive required information from the refrigerator 121 and generate the shopping information requested by the user terminal 112.

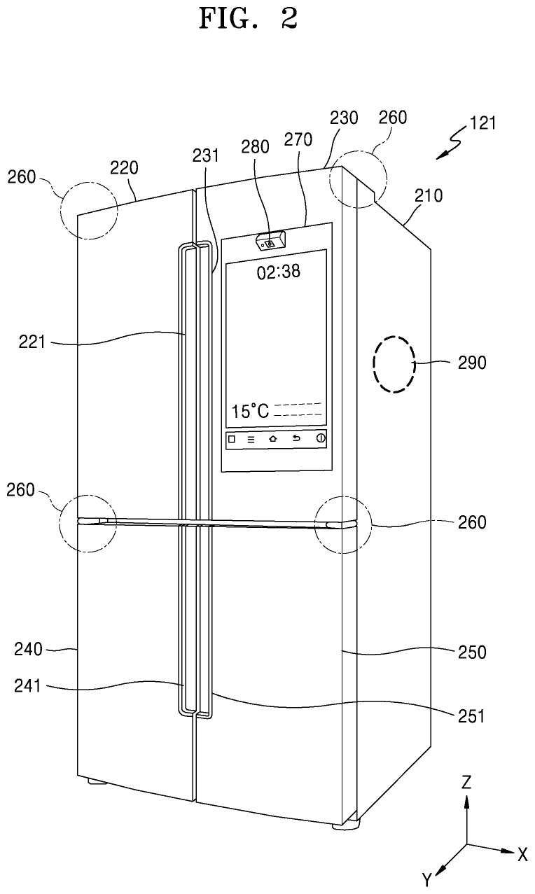

FIG. 2 is a diagram illustrating an external structure of a refrigerator according to an embodiment of the disclosure.

Referring to FIG. 2, the refrigerator 121 according to an embodiment may include a main body 210, at least one door 220, 230, 240, or 250, a hinge 260, a display 270, an external camera 280, and a communication module 290.

The main body 210 may form the exterior of the refrigerator 121. The main body 210 may prevent cold air inside the refrigerator 121 from leaking to the outside. The main body 210 may prevent warm air outside the refrigerator 121 from flowing into the inside. The main body 210 may include an insulator preventing inflow and outflow of cold air and warm air of the refrigerator 121.

The at least one door 220, 230, 240, or 250 may open or close a front side of the main body 210. The at least one door 220, 230, 240, or 250 may open or close the main body 210 while rotating with respect to a front edge of the main body 210 through the hinge 260. For example, the at least one door 220, 230, 240, or 250 may be arranged at a front upper left portion 221 of the main body 210, a front upper right portion 231 of the main body 210, a front lower left portion 241 of the main body 210, and a front lower right portion 251 of the main body 210. However, the disclosure is not limited thereto, and the number of the at least one door 220, 230, 240, or 250 and an arrangement position of the at least one door 220, 230, 240, or 250 may vary according to a design of the refrigerator 121.

The hinge 260 may connect the main body 210 and the at least one door 220, 230, 240, or 250 to each other. The hinge 260 may rotate the at least one door 220, 230, 240, or 250 by a set angle.

The display 270 may visually display information related to food items stored in the refrigerator 121. For example, the display 270 may display a list of food items stored in the refrigerator 121. For example, the display 270 may display an in/out record of food items stored in the refrigerator 121.

The external camera 280 may photograph the front exterior of the refrigerator 121. The external camera 280 may monitor the front exterior of the refrigerator 121.

The communication module 290 may be connected to a network. The communication module 290 may communicate with the user terminal 112 or the server 130.

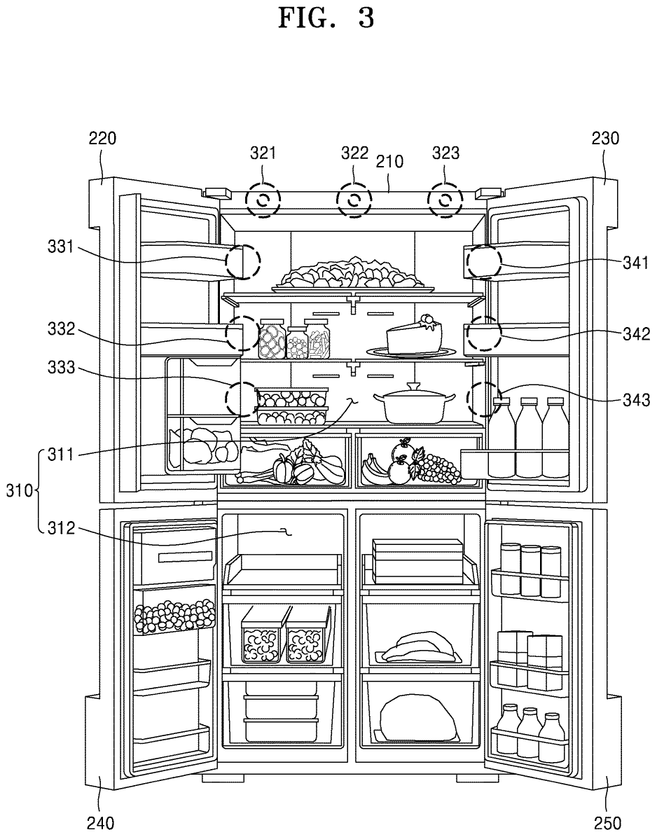

FIG. 3 is a diagram illustrating an internal structure of a refrigerator according to an embodiment of the disclosure.

Referring to FIG. 3, the refrigerator 121 according to an embodiment may include a storage compartment 310 and at least one camera 321, 322, 323, 331, 332, 333, 341, 342, or 343.

The storage compartment 310 may be formed inside the main body 210. The storage compartment 310 may keep food items refrigerated or frozen. The storage compartment 310 may include a fridge compartment 311 and a freezer compartment 312. The fridge compartment 311 may be a place where food items are stored cold at a temperature above zero. The freezer compartment 312 may be a place where food items are stored frozen at a temperature below zero.

The at least one camera 321, 322, 323, 331, 332, 333, 341, 342, or 343 may be arranged on at least one of an inner upper surface of the main body 210, an inner side surface of the main body 210, and the at least one door 220, 230, 240, or 250. For example, among the at least one camera 321, 322, 323, 331, 332, 333, 341, 342, or 343, inner upper cameras 321, 322, and 323 may be arranged on the inner upper surface of the main body 210. For example, among the at least one camera 321, 322, 323, 331, 332, 333, 341, 342, or 343, at least one inner left camera 331, 332, or 333 may be arranged on the inner left side surface of the main body 210 or at least one left door 220 or 240. For example, among the at least one camera 321, 322, 323, 331, 332, 333, 341, 342, or 343, at least one inner right camera 341, 342, or 343 may be arranged on the inner right side surface of the main body 210 or at least one right door 230 or 250.

The at least one camera 321, 322, 323, 331, 332, 333, 341, 342, or 343 may photograph the inside of the refrigerator 121. The at least one camera 321, 322, 323, 331, 332, 333, 341, 342, or 343 may photograph food items stocked in or taken out of the refrigerator 121. The at least one camera 321, 322, 323, 331, 332, 333, 341, 342, or 343 may photograph a user who stocks or takes food items in or out of the refrigerator 121. For example, the at least one camera 321, 322, 323, 331, 332, 333, 341, 342, or 343 may photograph the storage compartment 310. For example, the at least one camera 321, 322, 323, 331, 332, 333, 341, 342, or 343 may photograph a door bin that is a shelf provided inside the at least one door 220, 230, 240, or 250.

The at least one camera 321, 322, 323, 331, 332, 333, 341, 342, or 343 may form a photographing area to face the at least one door 220, 230, 240, or 250 above the refrigerator 121. The at least one camera 321, 322, 323, 331, 332, 333, 341, 342, or 343 may monitor the photographing area to identify whether the user stocks or takes food items in or out. The at least one camera 321, 322, 323, 331, 332, 333, 341, 342, or 343 may capture the photographing area when it is recognized that the user stocks or takes food items in or out.

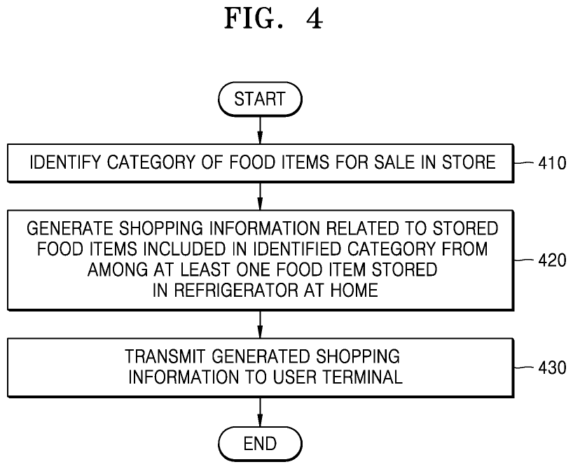

FIG. 4 is a flowchart illustrating a method of providing shopping information according to an embodiment of the disclosure.

Referring to FIG. 4, in operation 410, a system for providing shopping information, according to an embodiment of the disclosure, may identify a category of food items for sale in a store. The system for providing shopping information, according to an embodiment of the disclosure, may include a user terminal. For example, the user terminal may identify a type of the store in which a user is located and identify the category of food items for sale in the store. For example, the user terminal may identify a display stand at which the user is located in the store and identify food items for sale on the display stand at which the user is located. The user terminal may identify the category of the food items for sale based on results of the identification. For example, the user terminal may identify that the category of the food items for sale is vegetables, based on the results of identification.

In operation 420, the system for providing shopping information, according to an embodiment of the disclosure, may generate shopping information related to stored food items included in the identified category from among at least one food item stored in a refrigerator at home. The refrigerator or the server may determine, as the stored food item, a food item corresponding to the identified category of the food items for sale from among the at least one stored food item. For example, the refrigerator may determine, as the stored food item, a vegetable corresponding to the category of the food items for sale from among the at least one stored food item. In this case, the refrigerator may generate shopping information related to vegetables. For example, the server may determine, as the stored food item, a vegetable corresponding to the category of the food items for sale from among the at least one food item stored in the refrigerator. The server may receive a list of food items stored in the refrigerator from the refrigerator. The server may determine, as the stored food item, the vegetable corresponding to the category of the food items for sale in the received list of food items.

The shopping information may include the list of stored food items. The refrigerator may generate a list of food items belonging to the category identified as including the food items for sale from among the stored food items. For example, when the category of food items for sale is vegetables, the refrigerator may generate a list of food items, such as onions, carrots, and tomatoes, corresponding to vegetables from among the food items stored in the refrigerator.

The shopping information may include a location of the stored food item. The refrigerator may generate information related to a location where a food item belonging to the category identified as belonging to the food items for sale is stored. For example, when the category of the food items for sale is vegetables, the refrigerator may generate information for guiding where each of onions, carrots, and tomatoes corresponding to vegetables from among the food items stored in the refrigerator is stored. The refrigerator may generate information related to a location where a food item belonging to the category identified as belonging to the food items for sale is to be stored. For example, when the category of the food items for sale is vegetables, the refrigerator may generate information for guiding where each of onions, carrots, and tomatoes corresponding to vegetables from among the food items stored in the refrigerator is to be stored.

The shopping information may include an internal image displaying the stored food items. The refrigerator may obtain the internal image of the stored food items belonging to the category identified as belonging to the food items for sale. For example, when the category of the food items for sale is vegetables, the refrigerator may obtain an internal image obtained by photographing a portion where onions, carrots, and tomatoes corresponding to vegetables are stored from among the food items stored in the refrigerator. The refrigerator may generate information related to a location of the refrigerator where a food item belonging to the category identified as belonging to the food items for sale is to be stored. For example, when the category of the food items for sale is vegetables, the refrigerator may generate information for guiding where each of onions, carrots, and tomatoes corresponding to vegetables from among the food items stored in the refrigerator is to be stored.

The shopping information may include a requirement list requiring purchase in the category. The refrigerator may determine stocks of the stored food items and generate the requirement list in which food items required to be purchased in the category identified as belonging to the food items for sale are recorded. For example, when the category of the food items for sale is vegetables, the refrigerator may determine stocks of vegetables stored in the refrigerator and generate a requirement list that cucumbers and potatoes with insufficient stock are required to be purchased.

The shopping information may include recipe information related to the food items for sale and the stored food items. The refrigerator may generate a recipe related to food that may be made by using the food items for sale and the food items stored in the refrigerator. For example, when the food items for sale is beef, the refrigerator may generate a recipe for cooking bulgogi that may be made by using beef and onions stored in the refrigerator.

The shopping information may include recommended storage location information related to where to store the food items for sale in the refrigerator. The refrigerator may generate information including a recommended storage location where to store the food items for sale identified in the store in the refrigerator. For example, when the food items for sale is tomatoes, the refrigerator may generate information guiding, as the recommended storage location, a fresh food compartment suitable for storing tomatoes.

In operation 430, the system for providing shopping information, according to an embodiment of the disclosure, may transmit the generated shopping information to the user terminal. The refrigerator or the server may provide the shopping information related to the food items corresponding to the identified category to the user terminal. For example, the refrigerator may generate the shopping information related to the food items corresponding to the identified category and being stored, and provide the shopping information to the user terminal. For example, the server may request the refrigerator for information related to the food items stored in the refrigerator corresponding to the identified category. The server may generate the shopping information based on the information related to the stored food items of the refrigerator received from the refrigerator and provide the shopping information to the user terminal.

The user terminal may receive the shopping information from the refrigerator or the server. The user terminal may display the shopping information received from the refrigerator or the server. The shopping information may include information related to food items stored in the refrigerator corresponding to a category to which displayed food items belong. Accordingly, the system for providing shopping information, according to an embodiment of the disclosure, may automatically provide information related to food items currently stored in the refrigerator or food items required to be purchased to the user who wants to shop for food without a separate operation, thereby efficiently preventing redundant purchase or omission of purchase of food items. In addition, the system for providing shopping information, according to an embodiment of the disclosure, may determine a category of displayed food items displayed on a store or a display stand where the user is currently located, and provide shopping information corresponding to the identified category, thereby providing the shopping information suitable for a location and movements of the user in the store and improving shopping efficiency of the user in the store.

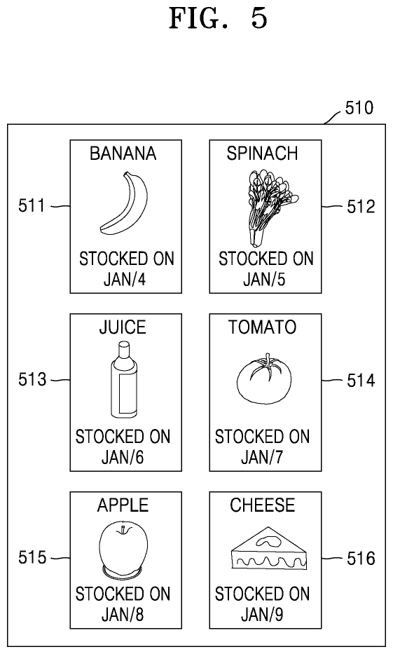

FIG. 5 is a diagram illustrating a refrigerator displaying food information 510 about food items stored in the refrigerator according to an embodiment of the disclosure.

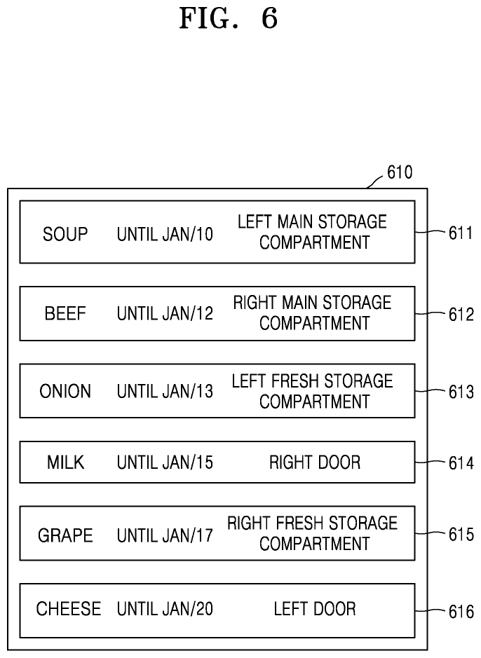

FIG. 6 is a diagram illustrating a refrigerator displaying food information 610 about food items stored in the refrigerator according to an embodiment of the disclosure.

FIGS. 5 and 6 may be specific examples included in an embodiment in which the refrigerator 121 displays food information. For example, when displaying food information, the refrigerator 121 may display the food information in the form including all of information shown in FIGS. 5 and 6, in the form as shown in FIG. 5, or in the form as shown in FIG. 6. However, the disclosure is not limited thereto, and the refrigerator 121 may display information related to food items stored in the refrigerator 121 in the form that may be commonly derived, in addition to the forms illustrated in FIGS. 5 and 6.

Referring to FIGS. 5 and 6, the refrigerator 121 or the server 130 may recognize food items stored in the refrigerator 121. The refrigerator 121 or the server 130 may generate the food information 510 including a list of stored food items. The refrigerator 121 may display the generated food information 510 on the display 270. The food information 510 may be stored in the refrigerator 121 or the server 130.

The food information 510 may include a names of a food item stored in the refrigerator 121, an image of the food item stored in the refrigerator 121, and a last stocked time of the food item stored in the refrigerator 121. The image of the food item stored in the refrigerator 121 may be an image obtained when the food item is stocked in the refrigerator 121. For example, the image of the food item stored in the refrigerator 121 may be an image captured through the at least one camera 321, 322, 323, 331, 332, 333, 341, 342, or 343 of the refrigerator 121 when the food item is stocked in the refrigerator 121.

The food information 510 may include a plurality of icons 511, 512, 513, 514, 515, and 516. For example, a first icon 511 included in the food information 510 may display a text indicating that the stored food item is a banana, an image of the banana, and content indicating that the banana was last stocked on January 4. For example, a second icon 512 included in the food information 510 may display a text indicating that the stored food item is spinach, an image of the spinach, and content that the spinach was last stocked on January 5. For example, a third icon 513 included in the food information 510 may display a text indicating that the stored food item is a juice, an image of the juice, and content indicating that the juice was last stocked on January 6. For example, a fourth icon 514 included in the food information 510 may display a text indicating that the stored food item is a tomato, an image of the tomato, and content indicating that the tomato was last stocked on January 7. For example, a fifth icon 515 included in the food information 510 may display a text indicating that the stored food item is an apple, an image of the apple, and content that the apple was last stocked on January 8. For example, a sixth icon 516 included in the food information 510 may display a text indicating that the stored food item is a cheese, an image of the cheese, and content indicating that the cheese was last stocked on January 9.

The refrigerator 121 or the server 130 may recognize the food items stored in the refrigerator 121. The refrigerator 121 or the server 130 may generate the food information 610 including a list of stored food items. The refrigerator 121 may display the generated food information 610 on the display 270. The food information 610 may be stored in the refrigerator 121 or the server 130.

The food information 610 may display a name of a food item stored in the refrigerator 121, an expiration date of the food item stored in the refrigerator 121, and a storage location of the food item stored in the refrigerator 121. For example, a first list 611 included in the food information 610 may display a text indicating that a stored food item is soup, a text indicating that an expiration date of the soup is until January 10, and content indicating that the soup is stocked in a left main storage compartment. For example, a second list 612 included in the food information 610 may display a text indicating that a stored food item is beef, a text indicating that an expiration date of the beef is until January 12, and content indicating that the beef is stocked in a right main storage compartment. For example, a third list 613 included in the food information 610 may display a text indicating that a stored food item is an onion, a text indicating that an expiration date of the onion is until January 13, and content indicating that the onion is stored in a left fresh storage compartment. For example, a fourth list 614 included in the food information 610 may display a text indicating that a stored food item is milk, a text indicating that an expiration date of the milk is until January 15, and content indicating that the milk is stored in a right door. For example, a fifth list 615 included in the food information 610 may display a text indicating that a stored food item is grapes, a text indicating that an expiration date of the grapes is until January 17, and content indicating that the grapes are stored in a right fresh storage compartment. For example, a sixth list 616 included in the food information 610 may display a text indicating that a stored food item is a cheese, a text indicating that an expiration date of the cheese is until January 20, and content indicating that the cheese is stored in a left door.

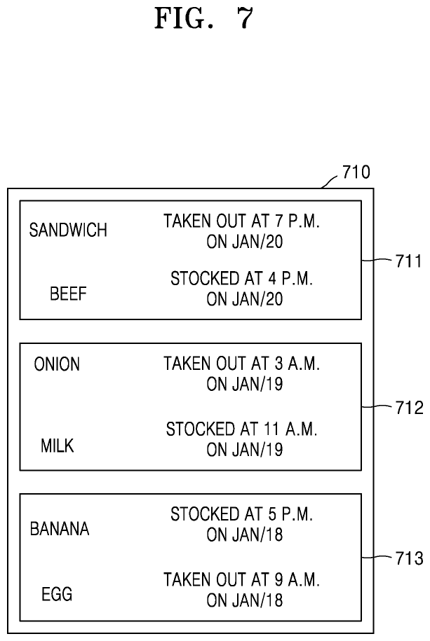

FIG. 7 is a diagram illustrating a refrigerator displaying an in/out record 710 of food items stocked in and taken out of the refrigerator according to an embodiment of the disclosure.

Referring to FIG. 7, the refrigerator 121 or the server 130 may recognize food items stocked in or taken out of the refrigerator 121. The refrigerator 121 or the server 130 may generate the in/out record 710, based on result of the recognition. The refrigerator 121 may display the generated in/out record 710 generated on the display 270. The in/out record 710 may be stored in the refrigerator 121 or the server 130.

The in/out record 710 may display a name of a food item stocked in the refrigerator 121 or taken out of the refrigerator 121, a classification of whether the food item has been stocked in the refrigerator 121 or the food item has been taken out of the refrigerator 121, and a time when the food item was stocked in the refrigerator 121 or a time when the food item was taken out of the refrigerator 121. For example, a first record 711 included in the in/out record 710 may display that a sandwich was taken out of the refrigerator 121 at 7 p.m. on January 20, and beef was stocked in the refrigerator 121 at 4 p.m. on January 20. For example, a second record 712 included in the in/out record 710 may display that an onion was taken out of the refrigerator 121 at 3 a.m. on January 19, and milk was stocked in the refrigerator 121 at 11 a.m. on January 19. For example, a third record 713 included in the in/out record 710 may display that a banana was stocked in the refrigerator 121 at 5 p.m. on January 18, and an egg was taken out of the refrigerator 121 at 9 a.m. on January 18. The in/out record 710 may display the user who has stocked or taken out a food item in or of the refrigerator 121.

The refrigerator 121 or the server 130 according to an embodiment may generate a list of food items required to be purchased. The refrigerator 121 or the server 130 may generate the list of food items required to be purchased based on a list of food items stored in the refrigerator 121, the in/out record 710, and planned diet information. For example, when a food item that is stocked or taken out a certain number of times is not present in a list of currently stored food items, the refrigerator 121 or the server 130 may add the corresponding food item to the list of food items required to be purchased. For example, the refrigerator 121 or the server 130 may add a food item required for a diet, which is not in the list of currently stored food items, to the list of food items required to be purchased. For example, the refrigerator 121 or the server 130 may add a food item expected to be consumed soon to the list of food items required to be purchased based on the in/out record 710 among currently stored food items. For example, the refrigerator 121 or the server 130 may add a food item having an imminent expiration date from among the currently stored food items to the list of food items required to be purchased. The list of food items required to be purchased may be stored in the refrigerator 121 or the server 130.

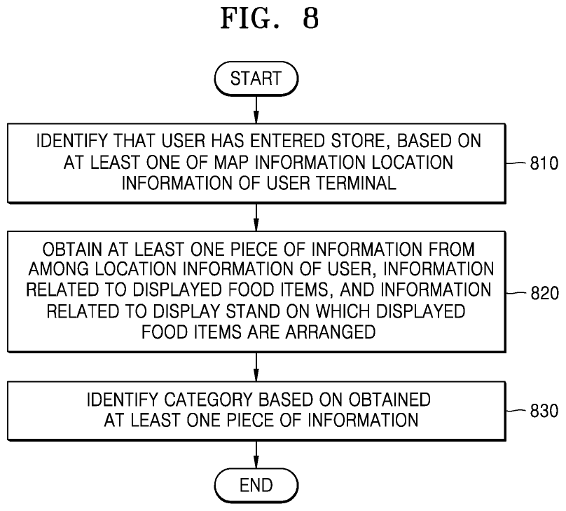

FIG. 8 is a flowchart illustrating a method of identifying a category of food items displayed in a store to provide shopping information according to an embodiment of the disclosure.

Referring to FIG. 8, in operation 810, a system for providing shopping information, according to an embodiment of the disclosure, may identify that a user has entered a store, based on at least one of map information and location information of a user terminal. The user terminal may obtain the location information and the map information of the user by using a positioning technology, such as a global positioning system (GPS) or a geo-fencing technology. The user terminal may recognize that the user has entered the store by using the location information and the map information. The store may be a food-only store or a general store. For example, the store may be a food-only store, such as a butcher shop, a fish shop, a vegetable shop, or a fruit shop. For example, the store may be a general store, such as a department store, a large discount store, or a supermarket.

In operation 820, the system for providing shopping information, according to an embodiment of the disclosure, may obtain at least one piece of information from among location information of the user, information related to displayed food items, and information related to a display stand on which the displayed food items are arranged. The displayed food items may refer to food items displayed on the display stand of the store from among food items for sale in the store. Because the food items for sale in the store are sold to the user after being arranged on the display stand, the displayed food items may be used interchangeably with the food items for sale below. The user terminal may obtain at least one piece of information from among a type of the store, corner information of the store, display stand information of the store, and a specific location of the user. The user terminal may identify a category of the food items, based on at least one of the type of the store, the corner information of the store, the display stand information of the store, and the specific location of the user. For example, the user terminal may recognize the type of store in which the user is located. For example, the user terminal may recognize the display stand or a corner where the user is located in the store. However, the disclosure is not limited thereto, and the user terminal may obtain at least one piece of information from among the location information of the user, the information related to displayed food items, and the information related to the display stand on which the displayed food items are arranged, by using any method, such as image capturing, map information, indoor positioning, code recognition, text input, or voice input.

In operation 830, the system for providing shopping information, according to an embodiment of the disclosure, may identify a category based on the obtained at least one piece of information. The category of the food items recognized in the store may be identified based on at least one of the location information of the user, the information related to the displayed food items, and the information related to the display stand on which the displayed food items are arranged. For example, the user terminal may determine the category of food items, based on a result of recognizing the type of the store in which the user is located. For example, the user terminal may determine the category of the food items, based on a result of recognizing the display stand or the corner where the user is located in the store.

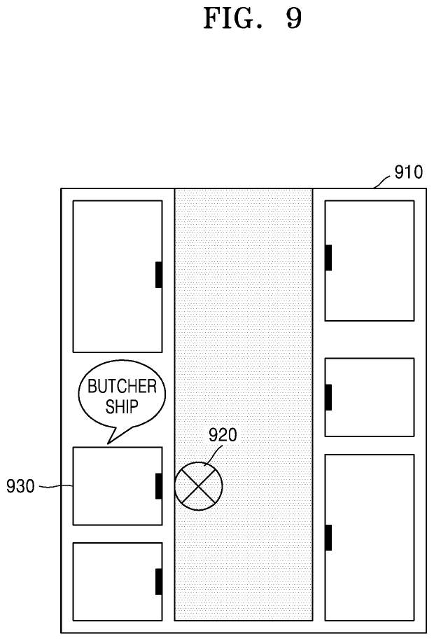

FIG. 9 is a diagram illustrating obtaining store information based on map information to identify a category according to an embodiment of the disclosure.

Referring to FIG. 9, the user terminal may obtain the map information and the location information of the user. For example, the user terminal may obtain a street map 910 and a location 920 of the user on a street. The street map 910 may include information related to a route the user travels, locations of stores, an entrance of each of the stores, a size of each of the stores, and a type of each of the stores.

The user terminal may recognize the user entering a store, based on the location information and the map information. For example, the user terminal may recognize the user entering an entrance of a store 930 located at a left center of the street map 910, based on the street map 910 and the location 920 of the user on the street.

The user terminal may identify whether a type of store the user has entered is an exclusive store that handles food items of a specific category, by using the location information and the map information. For example, the user terminal may identify that the store 930 the user is entering is a butcher shop handling meat, based on the street map 910 and the location 920 of the user on the street.

The user terminal may identify the category of the food items, based on the type of store when the type of store the user has entered is an exclusive store. For example, the user terminal may identify the category of the food items as meat, based on identifying that the user has entered the butcher shop based on the street map 910 and the location 920 of the user on the street. When the user terminal identifies the category as meat, a refrigerator may generate shopping information related to meat and provide the shopping information to the user terminal.

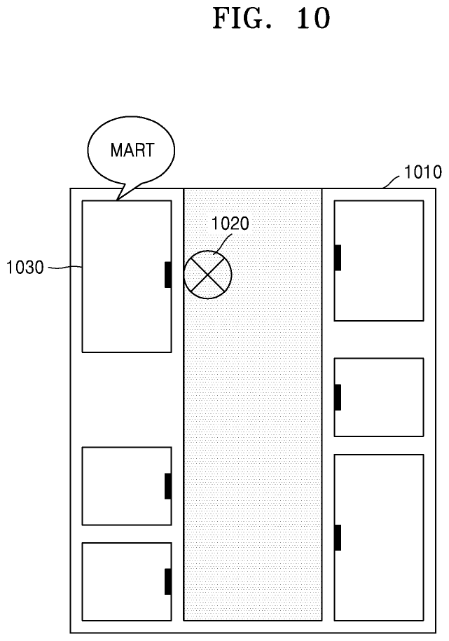

FIG. 10 is a diagram illustrating obtaining store information based on map information to identify a category according to an embodiment of the disclosure.

Referring to FIG. 10, the user terminal may obtain the map information and the location information of the user. For example, the user terminal may obtain a street map 1010 and a location 1020 of the user on a street. The street map 1010 may include information related to a route the user travels, locations of stores, an entrance of each of the stores, a size of each of the stores, and a type of each of the stores.

The user terminal may recognize the user entering a store, based on the location information and the map information. For example, the user terminal may recognize the user entering an entrance of a store 1030 located at an upper left of the street map 1010, based on the street map 1010 and the location 1020 of the user on the street.

The user terminal may identify whether a type of store the user has entered is a general store that handles food items of a plurality of categories, by using the location information and the map information. For example, the user terminal may identify that the store 1030 the user is entering is a mart, based on the street map 1010 and the location 1020 of the user on the street.

The user terminal may provide shopping information regardless of categories of food items when the type of store the user has entered is a general store. When the type of the store the user has entered is a general store, the user terminal may identify the category of the food items by additionally identifying the location of the user in the store. For example, the user terminal may receive the shopping information related to the mart from the refrigerator, based on identifying the user entering the mart based on the street map 1010 and the location 1020 of the user on the street. For example, the user terminal may identify the category of the food items by additionally identifying the location of the user in the mart, based on identifying the user entering the mart based on the street map 1010 and the location 1020 of the user on the street.

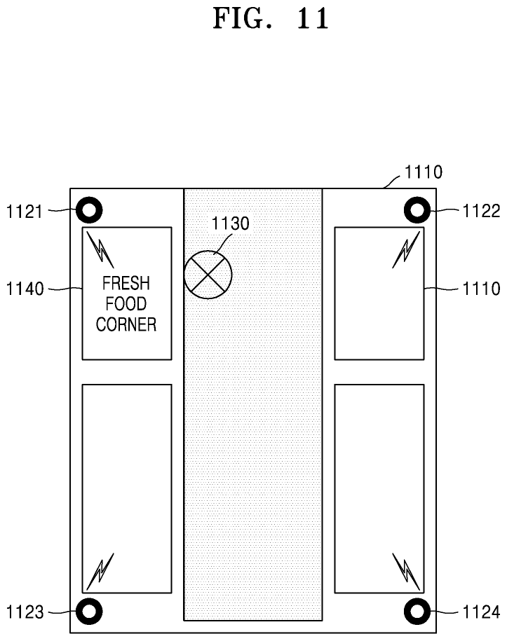

FIG. 11 is a diagram illustrating obtaining display stand information based on indoor information to identify a category according to an embodiment of the disclosure.

Referring to FIG. 11, the user terminal may obtain indoor information and the location information of the user in the store. For example, the user terminal may obtain an indoor map 1110 and a location 1130 of the user in an indoor space. The indoor map 1110 may include information related to a route a user travels, a location of a display stand or a corner, a size of the display stand or the corner, and a type of the display stand or the corner. The user terminal may obtain the location 1130 of the user from at least one positioning device 1121, 1122, 1123, or 1124 arranged in the indoor space of the store. The at least one positioning device 1121, 1122, 1123, or 1124 may be a beacon transmitting a unique signal. The beacon may transmit a wireless communication signal, such as Wi-Fi, ultra-wide band (UWB), or Bluetooth, an optical signal, or an acoustic signal, such as an ultrasonic signal. The user terminal may determine the location 1130 of the user by receiving a signal transmitted by the beacon.

The user terminal may identify display stand information related to a display stand or corner adjacent to the user, based on the indoor information. For example, the user terminal may recognize that the user is adjacent to a fresh food corner 1140 located upper left of the indoor map 1110, based on the indoor map 1110 and the location 1130 of the user in the indoor space.

The user terminal may identify a category of food items, based on the display stand information. For example, the user terminal may identify the category of the food items as vegetables when it is recognized that the user is adjacent to the fresh food corner 1140. When the user terminal identifies the category as vegetables, the refrigerator may generate shopping information related to vegetables and provide the shopping information to the user terminal.

When the user moves in the mart, the user terminal may obtain the location 1130 of the user in the indoor space in real time. The user terminal may obtain, in real time, the display stand information corresponding to the moved location 1130 of the user. The user terminal may identify, in real time, the category of the food items, based on the display stand information. Accordingly, the refrigerator may change the shopping information related to the identified category of food items in real time and provide the shopping information to the user terminal.

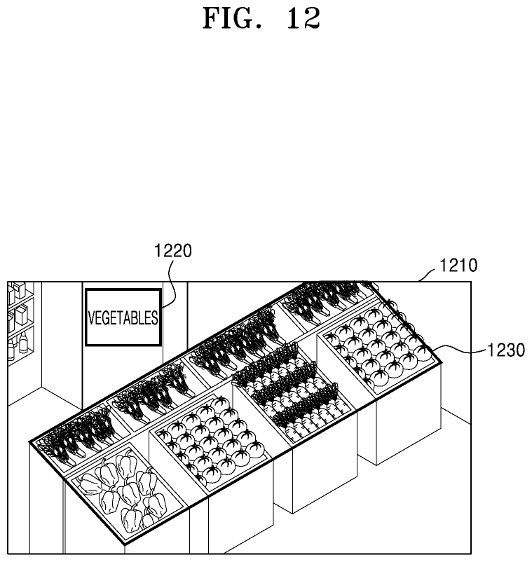

FIG. 12 is a diagram illustrating identifying a category based on a display image 1210 captured by a user terminal according to an embodiment of the disclosure.

Referring to FIG. 12, the user terminal may include a camera. The user terminal may photograph the display stand or the corner in the store by using the camera. The user terminal may obtain the display image 1210 by photographing the display stand or the corner in the store. For example, the user terminal may obtain the display image 1210 obtained by photographing a vegetable corner in the store.

The user terminal may recognize information related to a category of food items in the display image 1210. The user terminal may recognize an object related to the category of the food items in the display image 1210. The user terminal may recognize a text 1220 related to the category of the food items in the display image 1210. For example, the user terminal may recognize the text 1220 of “Vegetables” in the display image 1210. The user terminal may recognize a product image 1230 related to the category of the food items in the display image 1210. For example, the user terminal may recognize the product image 1230, such as tomatoes, carrots, or spinaches, in the display image 1210.

The user terminal may identify the category of the food items, based on information related to the category of the food items recognized in the display image 1210. The user terminal may identify the category of the food items, based on at least one of the text 1220 related to the category of the food items recognized in the display image 1210 or the product image 1230 related to the category of the food items. For example, when the text 1220 of “Vegetables” is recognized in the display image 1210, the user terminal may identify the category of the food items as vegetables. For example, when the user terminal recognizes the product image 1230 in the display image 1210 as a vegetable image, the user terminal may identify the category of the food items as vegetables. When the user terminal identifies the category as vegetables, the refrigerator may generate shopping information related to vegetables and provide the shopping information to the user terminal.

The user terminal may recognize a product code to identify the category of the food items. The user terminal may photograph the product code, such as a QR code or a barcode of food items by using the camera. The user terminal may obtain food information based on the photographed product code. The user terminal may identify the category of the food items, based on the obtained information.

The user terminal may receive a category of food items for which shopping information is to be provided. The user terminal may output a user interface (UI) for receiving the shopping information. The user may select the category of the food items for which the shopping information is to be provided through the UI. For example, the user may select the category of the food items for which the shopping information is to be provided from among the plurality of categories displayed on the UI. The user may directly input the category of the food items for which the shopping information is to be provided. For example, the user may directly input, by voice, the category of the food items for which the shopping information is to be provided.

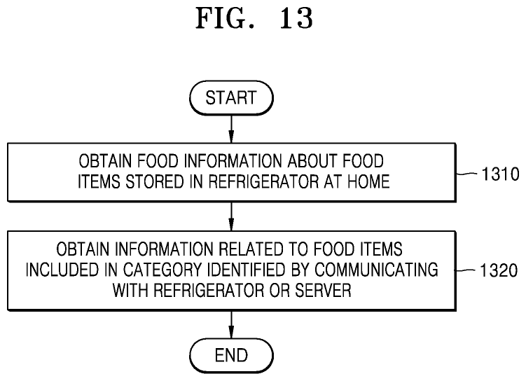

FIG. 13 is a flowchart illustrating a method of obtaining information related to food items included in an identified category to provide shopping information according to an embodiment of the disclosure.

Referring to FIG. 13, in operation 1310, a system for providing shopping information, according to an embodiment of the disclosure, may obtain food information about food items stored in a refrigerator at home. The refrigerator at home or a server communicating with the refrigerator at home may obtain the food information, such as a list of stored food items and an in/out record. The refrigerator at home or the server communicating with the refrigerator at home may store the obtained food information.

In operation 1320, the system for providing shopping information, according to an embodiment of the disclosure, may obtain information related to food items included in a category identified by communicating with the refrigerator or the server. A user terminal may communicate with the refrigerator or the server. The user terminal may request the information related to food items included in the identified category among the food information stored in the refrigerator or the server. The user terminal may receive the information related to food items included in the identified category from the refrigerator or the server. The user terminal may output shopping information related to the food items included in the identified category, based on the received information. When the category of the food items is not identified, the user terminal may output the shopping information, based on the entire food information stored in the refrigerator or the server.

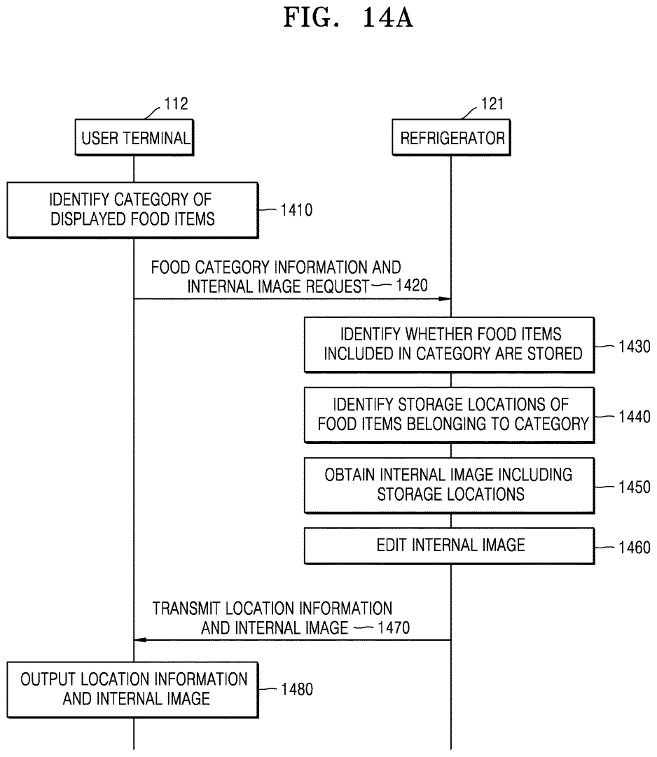

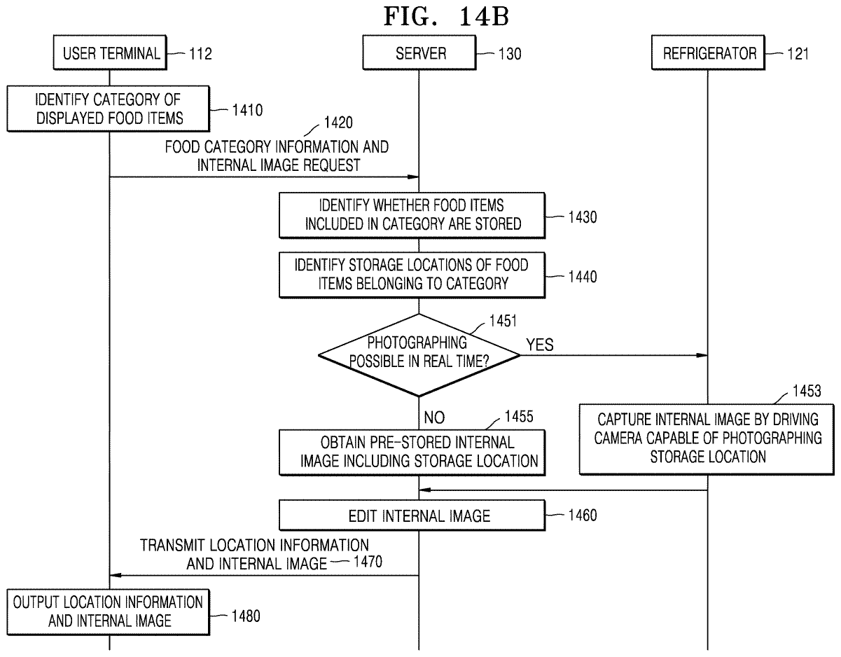

FIG. 14A is a diagram illustrating outputting of an internal image corresponding to a category to provide shopping information according to an embodiment of the disclosure.

Referring to FIG. 14A, in operation 1410, the user terminal 112 according to an embodiment of the disclosure may identify a category of displayed food items. The user terminal 112 may recognize that a user has entered a store. The user terminal 112 may determine a food category related to a location of the user.

In operation 1420, the user terminal 112 according to an embodiment of the disclosure may transmit food category information to the refrigerator 121. In operation 1420, the user terminal 112 according to an embodiment of the disclosure may transmit an internal image request to the refrigerator 121. The user terminal 112 may transmit the food category information to the refrigerator 121. The user terminal 112 may request to provide an internal image of the refrigerator 121.

In operation 1430, the refrigerator 121 according to an embodiment of the disclosure may identify whether food items belonging to the category are stored. The refrigerator 121 may store a list of stored food items and an in/out record. The refrigerator 121 may receive the food category information and the request from the user terminal 112. The refrigerator 121 that has received the food category information from the user terminal 112 may compare the food category information with the list of stored food items. The refrigerator 121 that has received the food category information from the user terminal 112 may compare the food category information with the in/out record. The refrigerator 121 may determine whether the food items belonging to the received food category are being stored, based on the list of stored food items and the in/out record.

In operation 1440, the refrigerator 121 according to an embodiment of the disclosure may identify storage locations of the food items belonging to the category. The refrigerator 121 may recognize that the food items belonging to the corresponding food category are currently being stored in the refrigerator 121. When it is recognized that the food items belonging to the category are being stored, the refrigerator 121 may identify locations where the corresponding food items are stored in the refrigerator 121, based on the in/out record or an internal preview image of the refrigerator 121.

In operation 1450, the refrigerator 121 according to an embodiment of the disclosure may obtain the internal image including the storage locations. The refrigerator 121 may photograph a location where a corresponding food item is stored by using a camera therein. The refrigerator 121 may capture the internal image in real time by controlling the camera for capturing the internal image.

When the refrigerator 121 includes a plurality of cameras respectively photographing a plurality of locations, the refrigerator 121 may selectively drive only a camera capable of photographing a location where a food item corresponding to the corresponding category is stored to capture the internal image. For example, when the refrigerator 121 includes internal cameras capable of respectively photographing an upper compartment, a center compartment, and a lower compartment of a storage compartment, and when a food item corresponding to the corresponding category is in the upper compartment, the refrigerator 121 may capture an internal image of the upper compartment by driving only the camera photographing the upper compartment.

When the refrigerator 121 is unable to capture the internal image in real time, the refrigerator 121 may obtain the internal image which has been most recently captured and stored. When there are a plurality of internal images obtained by photographing different internal locations in the refrigerator 121, the refrigerator 121 may obtain only an internal image obtained by photographing a location where a food item of the corresponding category is stored. For example, when the category is milk and the milk is currently stored in a door bin, the door bin is photographed only when a door of the refrigerator 121 is opened, and thus, the internal image may not be photographed in real time. In this case, the refrigerator 121 may obtain an internal image of the door bin photographed last instead of the internal image captured in real time.

In operation 1460, the refrigerator 121 according to an embodiment of the disclosure may edit the internal image. The refrigerator 121 may highlight and display the food items corresponding to the category of food items in the internal image. The refrigerator 121 may post-process the internal image to display information about the food items corresponding to the category of food items in the internal image. For example, when the category of food items in the internal image is milk, the refrigerator 121 may display a location and information of the milk in the internal image as a red rectangle.

In operation 1470, the refrigerator 121 according to an embodiment of the disclosure may transmit location information and the internal image. The refrigerator 121 may transmit, to the user terminal 112, the internal image and the food information about the food items being stored.

When there is currently no food item belonging to the category in the refrigerator 121, the refrigerator 121 may transmit, to the user terminal 112, information indicating that there is no food item of the corresponding category. When there is no food item belonging to the category in the refrigerator 121, the refrigerator 121 may transmit, to the user terminal 112, an image of the entire interior of the refrigerator 121. When there is no food item belonging to the category in the refrigerator 121, the refrigerator 121 may transmit, to the user terminal 112, information related to the food items stored in the entire interior of the refrigerator 121.

In operation 1480, the user terminal 112 according to an embodiment of the disclosure may output the location information and the internal image. The user terminal 112 may display the internal image and the food information about food items being stored, received from the refrigerator 121.

FIG. 14B is a diagram illustrating outputting of an internal image corresponding to a category to provide shopping information according to an embodiment of the disclosure.

Referring to FIG. 14B, in operation 1410, the user terminal 112 according to an embodiment of the disclosure may identify the category of the displayed food items. The user terminal 112 may recognize that the user has entered the store. The user terminal 112 may determine the food category related to the location of the user.

In operation 1420, the user terminal 112 according to an embodiment of the disclosure may transmit the food category information to the server 130. In operation 1420, the user terminal 112 according to an embodiment of the disclosure may transmit the internal image request to the server 130. The user terminal 112 may transmit the food category information to the server 130. The user terminal 112 may transmit, to the server 130, a signal requesting to provide the internal image of the refrigerator 121.

In operation 1430, the server 130 according to an embodiment of the disclosure may identify whether the food items belonging to the category are stored. The server 130 may receive the list of stored food items and the in/out record from the refrigerator 121. The server 130 may store the list of stored food items and the in/out record. The server 130 may receive the food category information and the request from the user terminal 112. The server 130 that has received the food category information from the user terminal 112 may compare the food category information with the stored list of stored food items. The server 130 that has received the food category information from the user terminal 112 may compare the food category information with the in/out record. The server 130 may determine whether the food items belonging to the received food category are being stored in the refrigerator 121, based on the list of stored food items and the in/out record.

In operation 1440, the server 130 according to an embodiment of the disclosure may identify the storage locations of food items belonging to the category. The server 130 may recognize that the food items belonging to the corresponding food category are currently being stored in the refrigerator 121. When it is recognized that the food items belonging to the category are being stored, the server 130 may identify locations where the corresponding food items are stored in the refrigerator 121, based on the in/out record or the internal preview image of the refrigerator 121.

In operation 1451, the server 130 according to an embodiment of the disclosure may identify whether photographing is possible in real time. The server 130 may identify whether the refrigerator 121 is able to photograph the inside of the refrigerator 121 in real time. When the refrigerator 121 is able to photograph the inside of the refrigerator 121 in real time (operation 1451—YES), the server 130 may request the refrigerator 121 to proceed to operation 1453. When the refrigerator 121 is unable to photograph the inside of the refrigerator 121 in real time (operation 1451—NO), the server 130 may proceed to operation 1455.

In operation 1453, the refrigerator 121 according to an embodiment of the disclosure may obtain the internal image by driving the camera capable of photographing the storage location. The refrigerator 121 may receive, from the server 130, a request to capture the internal image in real time. The refrigerator 121 may photograph a location where a corresponding food item is stored by using the camera therein. The refrigerator 121 may capture the internal image in real time by controlling the camera for capturing the internal image.

When the refrigerator 121 includes a plurality of cameras respectively photographing a plurality of locations, the refrigerator 121 may selectively drive only a camera capable of photographing a location where a food item corresponding to the corresponding category is stored to capture the internal image. For example, when the refrigerator 121 includes internal cameras capable of respectively photographing an upper compartment, a center compartment, and a lower compartment of a storage compartment, and when a food item corresponding to the corresponding category is in the upper compartment, the refrigerator 121 may capture an internal image of the upper compartment by driving only the camera photographing the upper compartment.

When the refrigerator 121 is unable to capture the internal image in real time, the refrigerator 121 may obtain the internal image which has been most recently captured and stored. When there are a plurality of internal images obtained by photographing different internal locations in the refrigerator 121, the refrigerator 121 may obtain only an internal image obtained by photographing a location where a food item of the corresponding category is stored. For example, when the category is milk and the milk is currently stored in a door bin, the door bin is photographed only when a door of the refrigerator 121 is opened, and thus, the internal image may not be photographed in real time. In this case, the refrigerator 121 may obtain an internal image of the door bin photographed last instead of the internal image captured in real time.

In operation 1455, the server 130 according to an embodiment of the disclosure may obtain a pre-stored internal image including the storage location. The server 130 may store the internal image previously received from the refrigerator 121. The server 130 may obtain the stored internal image when the refrigerator 121 is unable to photograph the inside of the refrigerator 121 in real time.

In operation 1460, the server 130 according to an embodiment of the disclosure may edit the internal image. The server 130 may highlight and display the food items corresponding to the category of food items in the internal image. The server 130 may post-process the internal image to display information about the food items corresponding to the category of food items in the internal image. For example, when the category of food items in the internal image is milk, the server 130 may display a location and information of the milk in the internal image as a red rectangle.

In operation 1470, the server 130 according to an embodiment of the disclosure may transmit the location information and the internal image. The server 130 may transmit, to the user terminal 112, the internal image and the food information about the food items being stored.

When there is currently no food item belonging to the category in the refrigerator 121, the server 130 may transmit, to the user terminal 112, information indicating that there is no food item of the corresponding category. When there is no food item belonging to the category in the refrigerator 121, the server 130 may transmit, to the user terminal 112, the image of the entire interior of the refrigerator 121. When there is no food item belonging to the category in the refrigerator 121, the server 130 may transmit, to the user terminal 112, the information related to the food items stored in the entire interior of the refrigerator 121.

In operation 1480, the user terminal 112 according to an embodiment of the disclosure may output the location information and the internal image. The user terminal 112 may display the internal image and the food information about food items being stored, received from the server 130.

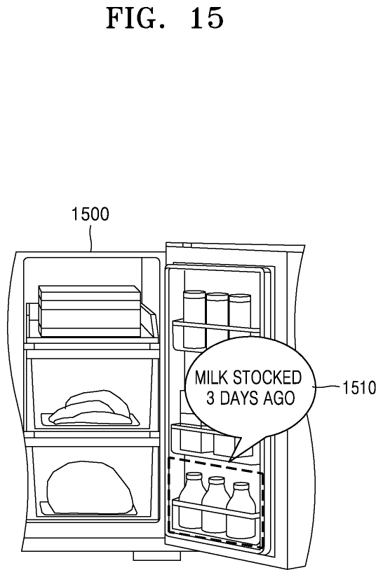

FIG. 15 is a diagram illustrating an internal image 1500 corresponding to a category according to an embodiment of the disclosure.

Referring to FIG. 15, the refrigerator 121 may obtain the internal image 1500. The refrigerator 121 may obtain the internal image 1500 of a current time or stored most recently. The internal image 1500 may visually display food items stored in the refrigerator 121. For example, the refrigerator 121 may visually display food items stored in each compartment of a storage compartment inside the refrigerator 121.

The refrigerator 121 may highlight and display food items corresponding to a category of food items in the internal image 1500. The refrigerator 121 may post-process the internal image 1500 so that information about food items corresponding to an identified category is displayed on the internal image 1500. For example, when a category in the internal image 1500 is milk, the refrigerator 121 may display 1510 a location of milk and stocked information of milk in the internal image 1500.

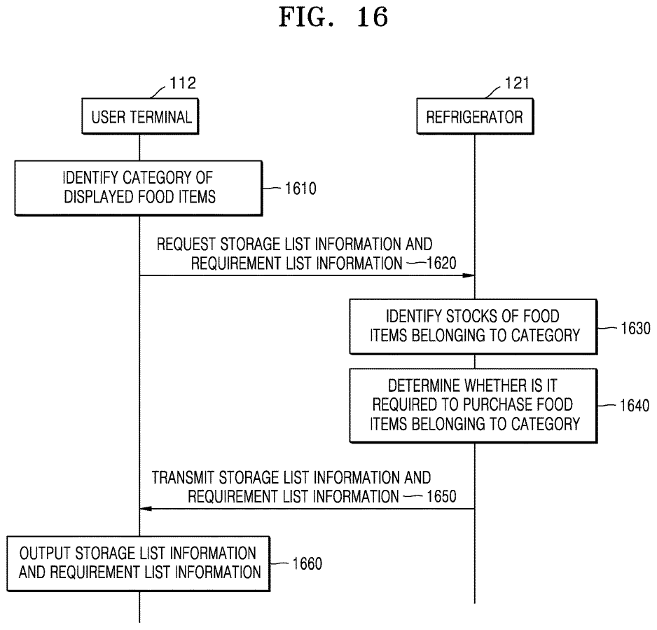

FIG. 16 is a diagram illustrating outputting of storage list information and requirement list information corresponding to a category to provide shopping information according to an embodiment of the disclosure.

FIG. 16 illustrates a case where the refrigerator 121 generates storage list information and requirement list information. However, the disclosure is not limited thereto, and the server 130 may generate the storage list information and the requirement list information.

Referring to FIG. 16, in operation 1610, the user terminal 112 according to an embodiment of the disclosure may identify a category of displayed food items. The user terminal 112 may recognize that a user has entered a store. The user terminal 112 may determine a food category related to a location of the user.

In operation 1620, the user terminal 112 according to an embodiment of the disclosure may request the storage list information and the requirement list information. The user terminal 112 may transmit food category information to the refrigerator 121 or the server 130. The user terminal 112 may request the refrigerator 121 or the server 130 for a list of required food items and food items to be purchased.

In operation 1630, the refrigerator 121 or the server 130 according to an embodiment of the disclosure may identify stocks of food items belonging to the category. The refrigerator 121 or the server 130 may receive, from the user terminal 112, a request to provide a requirement list. In response to receiving the request, the refrigerator 121 or the server 130 may search for the food items belonging to the category from the stored list of stored food items and the in/out record. The refrigerator 121 or the server 130 may identify the stocks of the food items belonging to the category, based on the list of stored food items and the in/out record.

In operation 1640, the refrigerator 121 or the server 130 according to an embodiment of the disclosure may determine whether it is required to purchase the food items belonging to the category. The refrigerator 121 or the server 130 may determine whether to add the food items belonging to the identified category to the requirement list. The refrigerator 121 or the server 130 may determine whether purchase of the food items is required, based on current stocks, expiration dates of food items currently being stored, in/out patterns of food items, and planned diet information. The refrigerator 121 or the server 130 may extract only food items belonging to the category from the list of food items required to be purchased stored in the refrigerator 121 or the server 130 and determine whether it is required to purchase the food items.

In operation 1650, the refrigerator 121 or the server 130 according to an embodiment of the disclosure may transmit the storage list information and the requirement list information. The refrigerator 121 or the server 130 may transmit, to the user terminal 112, the list of stored food items and the list of food items required to be purchased, the food items belonging to the category.

In operation 1660, the user terminal 112 according to an embodiment of the disclosure may output the storage list information and the requirement list information. The user terminal 112 may display the storage list information and the requirement list information received from the refrigerator 121 or the server 130.

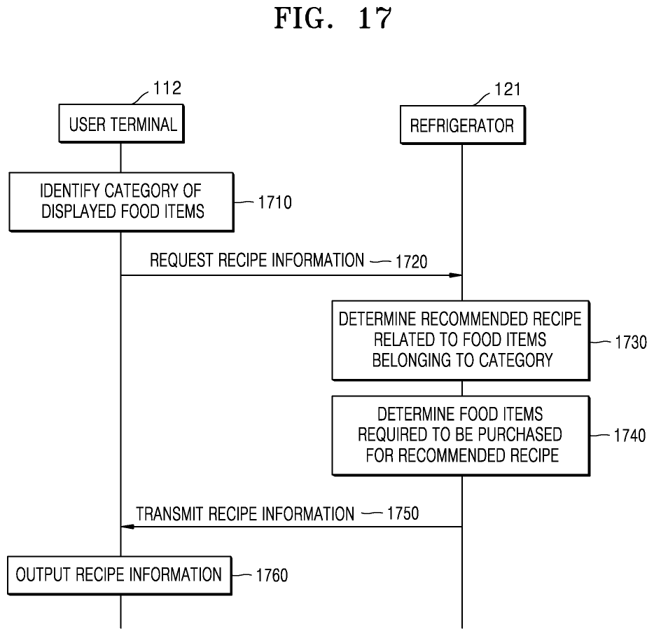

FIG. 17 is a diagram illustrating outputting of recipe information corresponding to a category to provide shopping information according to an embodiment of the disclosure.

FIG. 17 illustrates a case where the refrigerator 121 generates recipe information. However, the disclosure is not limited thereto, and the server 130 may generate the recipe information.

Referring to FIG. 17, in operation 1710, the user terminal 112 according to an embodiment of the disclosure may identify a category of displayed food items. The user terminal 112 may recognize that a user has entered a store. The user terminal 112 may determine a category of food items related to a location of the user.

In operation 1720, the user terminal 112 according to an embodiment of the disclosure may request the recipe information. When the category is determined, the user terminal 112 may transmit food category information to the refrigerator 121 or the server 130, and request a recipe recommendation.

In operation 1730, the refrigerator 121 or the server 130 according to an embodiment of the disclosure may determine a recommended recipe related to food items belonging to the category. The refrigerator 121 or the server 130 may receive, from the user terminal 112, a request to recommend a recipe. The refrigerator 121 or the server 130 may search a list of stored food items in response to receiving the request. The refrigerator 121 or the server 130 may determine the recommended recipe based on a recipe that may be generated by using food items currently stored in the refrigerator 121 and the food items belonging to the category.

In operation 1740, the refrigerator 121 or the server 130 according to an embodiment of the disclosure may determine food items required to be purchased for the recommended recipe. The refrigerator 121 or the server 130 may determine a food item currently lacking in the recommended recipe as the food item required to be purchased.

In operation 1750, the refrigerator 121 or the server 130 according to an embodiment of the disclosure may transmit the recipe information. The recipe information may include the recommended recipe and food information about food items required to be purchased to make the recipe. The refrigerator 121 or the server 130 may transmit, to the user terminal 112, the recommended recipe, the food items currently being stored among recipe ingredients, and the food information about food items required to be purchased.

In operation 1760, the user terminal 112 according to an embodiment of the disclosure may output the recipe information. The user terminal 112 may display the received recommended recipe and the food information about the food items required to be purchased.

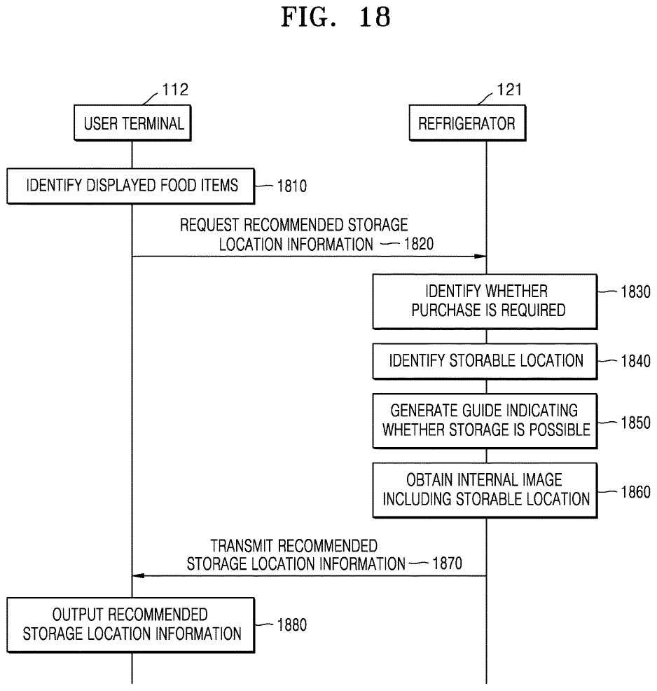

FIG. 18 is a diagram illustrating outputting of a recommended storage location of a displayed food item to provide shopping information according to an embodiment of the disclosure.

FIG. 18 illustrates a case where the refrigerator 121 generates a recommended storage location. However, the disclosure is not limited thereto, and the server 130 may generate the recommended storage location.

Referring to FIG. 18, in operation 1810, the user terminal 112 according to an embodiment of the disclosure may identify displayed food items. The user terminal 112 may recognize a product code of the food item. The user terminal 112 may capture an image of the food item. The user terminal 112 may obtain food information based on the product code of the food item or the image of the food item.

In operation 1820, the user terminal 112 according to an embodiment of the disclosure may request recommended storage location information. The user terminal 112 may transmit the food information to the refrigerator 121 or the server 130. The user terminal 112 may request the refrigerator 121 or the server 130 to provide the recommended storage location information.

In operation 1830, the refrigerator 121 or the server 130 according to an embodiment of the disclosure may identify whether purchase is required. The refrigerator 121 or the server 130 may identify stocks of the recognized food items, based on a list of stored food items. The refrigerator 121 or the server 130 may determine whether it is required to purchase the recognized food items, based on the list of stored food items.

In operation 1840, the refrigerator 121 or the server 130 according to an embodiment of the disclosure may identify a storable location. When it is required to purchase the recognized food items, the refrigerator 121 or the server 130 may identify whether there is a location at which the recognized food item is able to be stored in the refrigerator 121 when the recognized food item is purchased.

In operation 1850, the refrigerator 121 or the server 130 according to an embodiment of the disclosure may generate a guide indicating whether storage is possible. When there is an available storage space for the recognized food item, the refrigerator 121 or the server 130 may display a guide indicating that the recognized food item is able to be stored. When there is no available storage space for the recognized food item, the refrigerator 121 or the server 130 may display a guide indicating that the recognized food item is unable to be stored.

In operation 1860, the refrigerator 121 or the server 130 according to an embodiment of the disclosure may obtain an internal image including the storable location. The refrigerator 121 or the server 130 may obtain stock information and an internal image of a location where the corresponding food item is currently stored, when there is a stock of the food item and the food item is not required to be purchased. When there is no stock of the food item and there is an available storage space for the food item, the refrigerator 121 or the server 130 may provide an internal image of a location where the food item to be purchased may be stored. The refrigerator 121 or the server 130 may provide information indicating that the food item to be purchased is unable to be stored when there is no available storage space for the food item. The refrigerator 121 or the server 130 may provide an internal image or an entire internal image indicating that the food item is unable to be stored when there is no available storage space for the food item. When there is no stock of the food item and there is no available storage space of the food item, the refrigerator 121 or the server 130 may provide an internal image showing an alternative storage space of the food item to be purchased.

In operation 1870, the refrigerator 121 or the server 130 according to an embodiment of the disclosure may transmit the recommended storage location information. The refrigerator 121 or the server 130 may transmit an internal image indicating a recommended storage location to the user terminal 112.

In operation 1880, the user terminal 112 according to an embodiment of the disclosure may output the recommended storage location information. The user terminal 112 may display the received recommended storage location information.

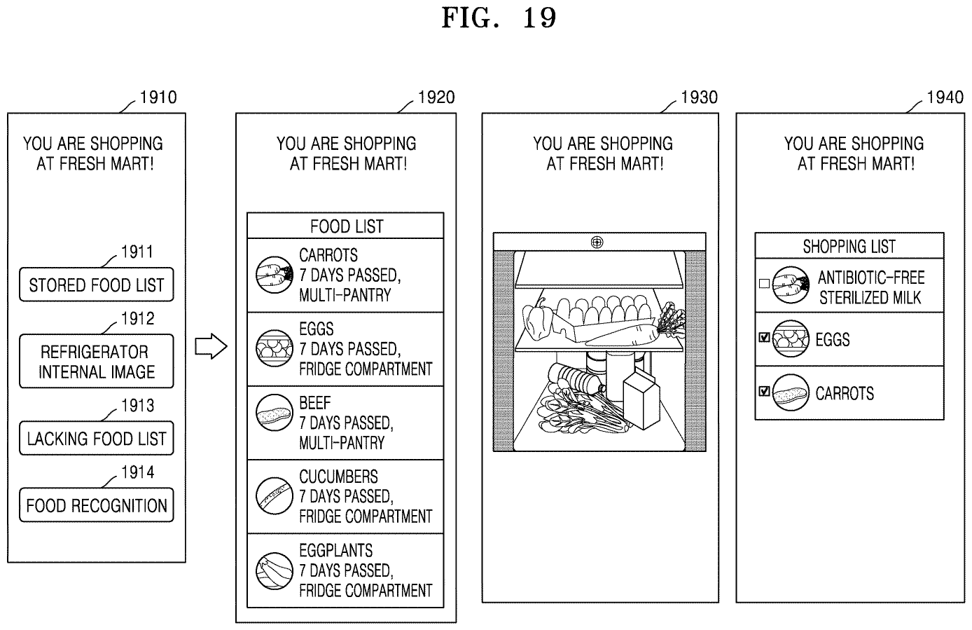

FIG. 19 is a diagram illustrating a UI of a case where a category of a food item is not identified when entering a store, to provide shopping information, according to an embodiment of the disclosure.

For example, when a user enters a general store, such as a mart, a category of food items is not identified, and thus, a user terminal may display a UI as shown in FIG. 19.

Referring to FIG. 19, the user terminal 112 according to an embodiment may display a first UI 1910 when entering a store and a category of food items is not identified. The user terminal 112 may notify that a user has entered the store, on the first UI 1910. The user terminal 112 may display, on the first UI 1910, a guide related to the entered store. For example, the user terminal 112 may display a guide of “You are shopping at Fresh Mart!” on the first UI 1910.

The user terminal 112 may display, on the first UI 1910, menus related to food information that may be obtained from the entered store. The user terminal 112 may display menus requesting the user's selection to display shopping information on the first UI 1910. The user terminal 112 may display sub-menus for selecting food information unrelated to the category of the food items in the entered store. For example, the user terminal 112 may display a stored food list menu 1911, a refrigerator internal image menu 1912, a lacking food list menu 1913, and a menu for food recognition 1914.

When the stored food list menu 1911 is selected, the user terminal 112 may display a stored food list UI 1920. The stored food list UI 1920 may display information about all categories of food items stored in the refrigerator 121. The stored food list UI 1920 may include images of food items stored in the refrigerator 121, types of the food items stored in the refrigerator 121, storage periods of the food items stored in the refrigerator 121, and storage locations of the food items stored in the refrigerator 121.

When the refrigerator internal image menu 1912 is selected, the user terminal 112 may display an internal image UI 1930. The internal image UI 1930 may display an internal image of the entire refrigerator 121. The internal image UI 1930 may display the internal image of the refrigerator 121 to check the food items stored in the refrigerator 121 as a whole.

When the lacking food list menu 1913 is selected, the user terminal 112 may display a lacking food list UI 1940. The lacking food list UI 1940 may display information about all categories of food items that are out of stock or required to be purchased. The lacking food list UI 1940 may include an image of a food item required to be purchased and a type of the food item required to be purchased.

When the food recognition 1914 is selected, the user terminal 112 may display a UI capable of directly recognizing the food items of the store. The user terminal 112 may photograph the food items of the store or directly recognize product codes on the food items of the store to identify the category of the food items.

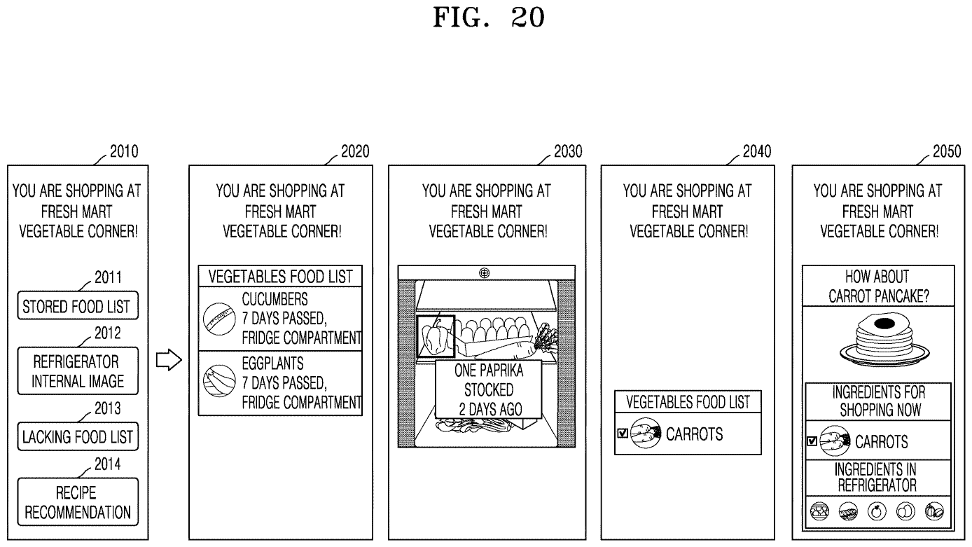

FIG. 20 is a diagram illustrating a UI of a case where a category of a food item is identified when entering a store, to provide shopping information, according to an embodiment of the disclosure.

For example, when a user has entered a store and is in a specific display stand or corner, a category of food items has been identified, and thus, a user terminal may display a UI as shown in FIG. 20.

Referring to FIG. 20, the user terminal 112 according to an embodiment may display a second UI 2010 when entering a store and a category of food items is identified. The user terminal 112 may notify, on the second UI 2010, that the category of food items has been identified. The user terminal 112 may guide that a user is in a specific display stand or corner of the store, in the second UI 2010. For example, the user terminal 112 may display a guide of “You are shopping at Fresh Mart vegetable corner!” on the second UI 2010.

The user terminal 112 may display, on the second UI 2010, menus related to the identified category. The user terminal 112 may display, on the second UI 2010, menus requesting the user's selection to display shopping information. The user terminal 112 may display sub-menus for selecting food information corresponding to the category of food items in the entered store. For example, the user terminal 112 may display a stored food list menu 2011, a refrigerator internal image menu 2012, a lacking food list menu 2013, and a menu for recipe recommendation 2014.

When the stored food list menu 2011 is selected, the user terminal 112 may display a stored food list UI 2020. The stored food list UI 2020 may display information about the identified category from among the food items stored in the refrigerator 121. For example, when the identified category is vegetables, the stored food list UI 1920 may include images of food items stored in the refrigerator 121, types of the food items stored in the refrigerator 121, storage periods of the food items stored in the refrigerator 121, and storage locations of the food items stored in the refrigerator 121.

When the refrigerator internal image menu 2012 is selected, the user terminal 112 may display an internal image UI 2030. The internal image UI 2030 may display an internal image obtained by photographing a location where a food item corresponding to the category is stored in the refrigerator 121. For example, when the identified category is vegetables, the internal image UI 2030 may display an internal image obtained by photographing locations where vegetables are stored in the refrigerator 121.

The internal image UI 2030 may include stocked information of the food items corresponding to the category. For example, when the identified category is vegetables, the internal image UI 2030 may include a text indicating that one paprika was stocked in the refrigerator 121 2 days ago. For example, when the identified category is vegetables, the user terminal 112 may highlight a location where the paprika was stocked in the internal image UI 2030 in a square shape.

When the lacking food list menu 2013 is selected, the user terminal 112 may display a lacking food list UI 2040. The lacking food list UI 2040 may display information about food items that are out of stock or required to be purchased in the identified category. For example, when the identified category is vegetables, the user terminal 112 may determine that a food item that is required to be purchased is carrots, and may display, on the lacking food list UI 2040, a carrot image and that a food item required to be purchased is carrots.

When the recipe recommendation 2014 is selected, the user terminal 112 may display a recipe recommendation UI 2050. The user terminal 112 may display a recommended recipe related to the food item to be purchased on the recipe recommendation UI 2050. For example, when the food item to be purchased is carrots, the user terminal 112 may display the recipe recommendation UI 2050 for recommending a recipe of a carrot pancake that may be made using carrots.

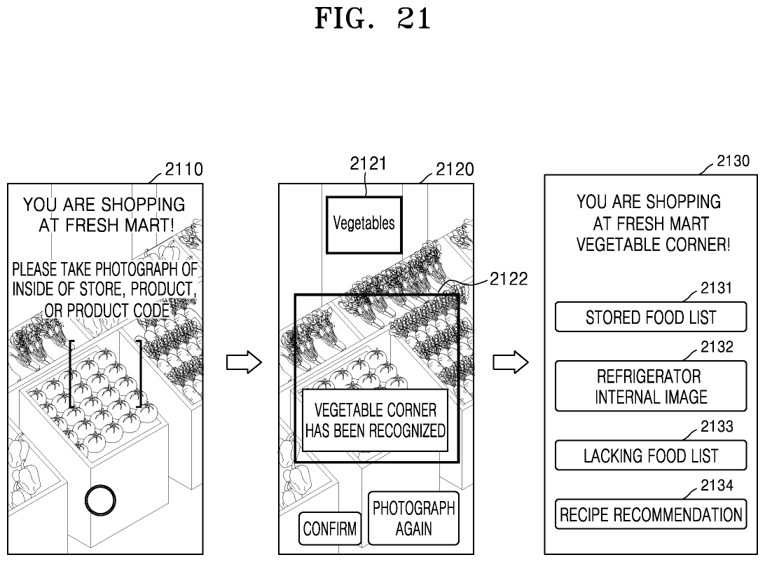

FIG. 21 is a diagram illustrating a UI of a case where a category of a food item is identified according to a user input, to provide shopping information, according to an embodiment of the disclosure.

For example, when a user directly recognizes a product code of a specific food item, a category of the food item is individually recognized, and thus, a user terminal may display a UI as shown in FIG. 21.

Referring to FIG. 21, the user terminal 112 according to an embodiment may display a third UI 2110 when a category of food items is to be identified according to a user input. The user terminal 112 may request, on the third UI 2110, to take a photograph to identify the category of the food items. The user terminal 112 may guide, on the third UI 2110, that the category of the food items may be identified by photographing information related to the food items. For example, the user terminal 112 may display, on the third UI 2110, a guide of “Please take photograph of inside of store, product, or product code”. The user terminal 112 may display the third UI 2110 at a time point at which it is recognized that a user has entered a store, to guide the user to take a photograph.

After the user enters the store, the user terminal 112 may make a request when the user selects the first UI 1910 to directly identify the category of food items. The user terminal 112 may make a request when it is failed to automatically recognize the category after the user has entered the store.

The user terminal 112 may receive, through the third UI 2110, an input other than image recognition by camera photographing. For example, the user terminal 112 may guide a voice input through the third UI 2110. For example, the user terminal 112 may guide a text input through the third UI 2110. For example, the user terminal 112 may receive, through the third UI 2110, an input for selecting a category desired to receive shopping information from among preset categories.

When the user captures a food image after the third UI 2110 is displayed, the user terminal 112 according to an embodiment may display a food image 2120. The user terminal 112 may display photographed food items on the food image 2120.

The user terminal 112 may extract an object related to a category of the food items from the food image 2120. The user terminal 112 may extract a text related to the category of the food items from the food image 2120. For example, the user terminal 112 may extract a text 2121 “Vegetables” from the food image 2120. For example, the user terminal 112 may display a highlight mark 2122 emphasizing a vegetable image in the food image 2120. The user terminal 112 may display the identified category of the food items on the food image 2120. For example, the user terminal 112 may display, on the food image 2120, a guide of “Vegetable corner has been recognized”.

The user may select a confirmation menu for approving the identified category from the food image 2120 and display a menu related to the identified category. When the user wants to display a menu related to a category other than the category identified in the food image 2120, the user may select a photographing menu again and obtain a food image again.

The user terminal 112 may display a third UI 2130 when shopping information related to the identified category is to be displayed. The user terminal 112 may display, on the third UI 2130, menus related to the identified category. The user terminal 112 may display menus requesting the user's selection to display the shopping information on the third UI 2130. The user terminal 112 may display sub-menus for selecting food information corresponding to the category of food items in the entered store. For example, the user terminal 112 may display a stored food list menu 2131, a refrigerator internal image menu 2132, a lacking food list menu 2133, and a menu for recipe recommendation 2134.

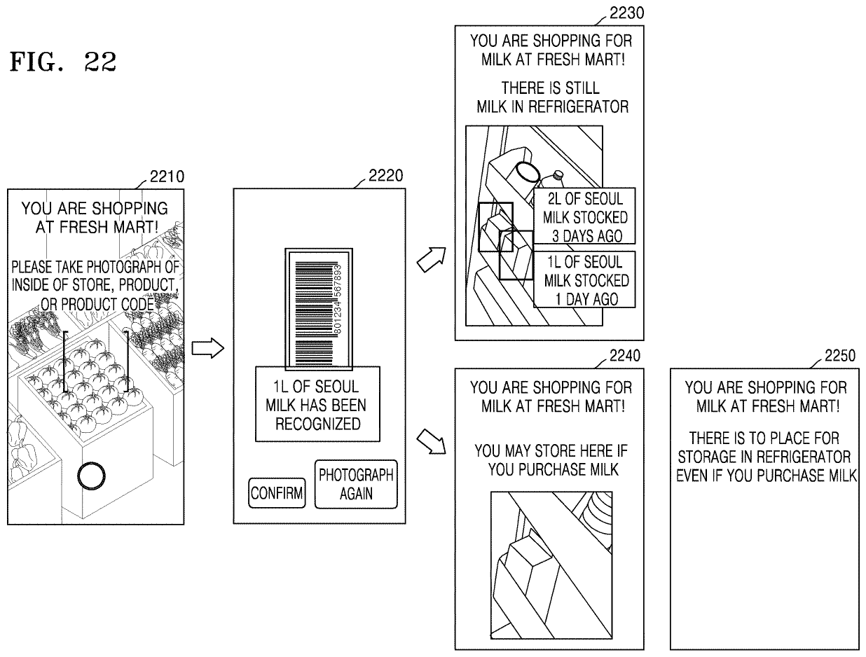

FIG. 22 is a diagram illustrating a UI of a case where an individual food item is identified according to a user input, to provide shopping information, according to an embodiment of the disclosure.

Referring to FIG. 22, the user terminal 112 according to an embodiment may display a fourth UI 2210 when a category of food items is to be identified according to a user input. The user terminal 112 may request, on the fourth UI 2210, to take a photograph to identify the category of the food items. The user terminal 112 may guide, on the fourth UI 2210, that the category of the food items may be identified by photographing information related to the food items. For example, the user terminal 112 may display, on the fourth UI 2210, a guide of “Please take photograph of inside of store, product, or product code”. The user terminal 112 may display the fourth UI 2210 at a time point at which it is recognized that a user has entered a store, to guide the user to take a photograph.

The user terminal 112 according to an embodiment may display a product code screen 2220 when a user photographs a food code after the fourth UI 2210 is displayed. The user terminal 112 may extract food information from the product code screen 2220. The user terminal 112 may display the food information extracted from the product code screen 2220. For example, the user terminal 112 may display the food information of “1 L of Seoul Milk has been recognized” on the product code screen 2220.

The user terminal 112 may request the refrigerator 121 to transmit information about identified food items in response to the user selecting a confirmation menu for approving the identified food items on the product code screen 2220. When a product other than the food item identified in the product code screen 2220 is to be recognized, the user terminal 112 may select a photographing menu again and obtain a product code again.

The refrigerator may determine stock information of the food item identified in the food image 2120 and whether there is a location for storage in the refrigerator when the identified food item is purchased. The refrigerator may transmit, to the user terminal 112, information obtained as a result of the determination.

The user terminal 112 may display a stock guide UI 2230 when a stock of the identified food item is in the refrigerator. The user terminal 112 may display, on the stock guide UI 2230, a phrase guiding that the stock of the identified food item is left. For example, the user terminal 112 may display a guide phrase of “There is still milk in refrigerator” on the stock guide UI 2230. The user terminal 112 may display, on the stock guide UI 2230, an internal image of the refrigerator showing the stock of the identified food item. The user terminal 112 may display, on the internal image, information related to stocked food items, such as types of the stocked food items and stocked dates of the stocked food items. The user terminal 112 may highlight the stocked food items in the internal image. For example, the user terminal 112 may highlight milk in the internal image as a rectangular box.

The user terminal 112 may display a storage location guide UI 2240 when there is a location for storage in the refrigerator when the identified food item is purchased. The user terminal 112 may display, on the storage location guide UI 2240, an internal image indicating the location for storage in the refrigerator when the identified food item is purchased. For example, the user terminal 112 may display, on the storage location guide UI 2240, an internal image indicating a door bin for storage when milk is purchased. The user terminal 112 may guide, on the storage location guide UI 2240, the location for storage in the refrigerator when the identified food item is purchased. For example, the user terminal 112 may display, on the storage location guide UI 2240, a guide phrase of “You may store here if you purchase milk”.

When the identified food item is purchased and there is no location for storage in the refrigerator, the user terminal 112 may display a storage impossible guide UI 2250. The user terminal 112 may provide, on the storage impossible guide UI 2250, a guide indicating that there is no location for storage in the refrigerator when the identified food item is purchased. For example, the user terminal 112 may display, on the storage impossible guide UI 2250, a guide phrase of “There is no place for storage in refrigerator even if you purchase milk”. The user terminal 112 may display a UI guiding an alternative location for storage when the identified food item is purchased, instead of the storage impossible guide UI 2250.

A method of providing shopping information, according to the disclosure, includes identifying a category of food items for sale in a store, generating shopping information related to stored food items included in the identified category from among at least one food item stored in a refrigerator at home, and transmitting the generated shopping information to a user terminal, wherein the shopping information may include at least one of a list of the stored food items, locations of the stored food items, an internal image of the refrigerator displaying the stored food items, a requirement list requiring purchase in the category, recipe information related to the food items for sale and the stored food items, and recommended storage location information related to where the food items for sale are to be stored in the refrigerator.

The method of providing shopping information, according to the disclosure, may include identifying, by the user terminal, that a user has entered the store by using location information and map information.

The method of providing shopping information, according to the disclosure, may include obtaining, by the refrigerator, the internal image of the refrigerator by photographing the inside of the refrigerator and the at least one food item stocked in and taken out of the refrigerator by using at least one camera.

The identifying of the category, according to the disclosure, may include obtaining, by the user terminal, at least one piece of information from among location information of the user, information related to displayed food items, and information related to a display stand where the displayed food items are arranged, and identifying the category based on the obtained at least one piece of information.

The generating of the shopping information, according to the disclosure, may include requesting, by the user terminal, the internal image corresponding to the category, identifying whether the stored food items are stored and storage locations of the stored food items, obtaining the internal image including the storage locations, and transmitting the internal image to the user terminal.

The method of providing shopping information, according to the disclosure, may include, based on the stored food items corresponding to the category not being present in the refrigerator, transmitting, to the user terminal, information indicating that the stored food items are not present and an entire internal image of the refrigerator.

The generating of the shopping information, according to the disclosure, may include requesting, by the user terminal, the refrigerator for the requirement list requiring the purchase corresponding to the category, determining whether purchase of the food items for sale is required, and transmitting the requirement list to the user terminal.

The generating of the shopping information, according to the disclosure, may include requesting, by the user terminal, the refrigerator for the recipe information corresponding to the category, determining a recommended recipe related to the stored food items and the food items for sale, and transmitting the recipe information to the user terminal.

The generating of the shopping information, according to the disclosure, may include requesting, by the user terminal, the refrigerator for the recommended storage location information corresponding to the category, identifying whether the food items for sale are storable in a recommended storage location corresponding to the category, and transmitting, to the user terminal, the recommended storage location information including the recommended storage location.

The method for providing shopping information, according to the disclosure, may include, based on the food items for sale being unable to be stored at the recommended storage location in the refrigerator, transmitting, to the user terminal, guide information indicating that the food items for sale are unable to be stored or alternative storage location information for storing the food items for sale other than the recommended storage location.

A refrigerator to which a method of providing shopping information, according to the disclosure, is applied may include the communication module 190, the at least one camera 321, 322, 323, 331, 332, 333, 341, 342, or 343, and at least one processor, wherein the at least one processor is configured to receive, from the user terminal 112, a result of identifying a category of food items for sale in a store, generate shopping information related to stored food items included in the identified category from among at least one stored food item, and transmit the generated shopping information to the user terminal 112, wherein the shopping information may include at least one of a list of the stored food items, locations of the stored food items, an internal image displaying the stored food items, a requirement list requiring purchase in the category, recipe information related to the food items for sale and the stored food items, and recommended storage location information related to where the food items for sale are to be stored.

The at least one processor, according to the disclosure, may be further configured to receive a result of identifying, by the user terminal, that a user has entered the store by using location information and map information.

The at least one processor, according to the disclosure, may be further configured to obtain the internal image of the refrigerator by photographing the inside of the refrigerator and at least one food item stocked in and taken out of the refrigerator by using at least one camera.

The at least one processor, according to the disclosure, may be further configured to receive at least one piece of information obtained by the user terminal from among location information of the user, information related to displayed food items, and information related to a display stand where the displayed food items are arranged, and identify the category based on the obtained at least one piece of information.

The at least one processor, according to the disclosure, may be further configured to receive, from the user terminal, a signal requesting the internal image corresponding to the category, identify whether the stored food items are stored and storage locations of the stored food items, obtain the internal image including the storage locations, and transmit the internal image to the user terminal.

The at least one processor, according to the disclosure, may be further configured to, based on the stored food items corresponding to the category not being present in the refrigerator, transmit information indicating that the stored food items are not present and an entire internal image of the refrigerator to the user terminal.

The at least one processor, according to the disclosure, may be further configured to receive a signal requesting, by the user terminal, the requirement list requiring purchase corresponding to the category, determine whether purchase of the food items for sale is required, and transmit the requirement list to the user terminal.

The at least one processor, according to the disclosure, may be further configured to receive the signal requesting, by the user terminal, the recipe information corresponding to the category, determine a recommended recipe related to the stored food items and the food items for sale, and transmit the recipe information to the user terminal.

The at least one processor according to the disclosure may be further configured to receive a signal requesting, by the user terminal, the recommended storage location information corresponding to the category, identify whether the food items for sale are storable in a recommended storage location corresponding to the category, and transmit the recommended storage location information including the recommended storage location to the user terminal.

The at least one processor, according to the disclosure, may be further configured to, based on the food items for sale being unable to be stored at the recommended storage location in the refrigerator, transmit, to the user terminal, guide information indicating that the food items for sale are unable to be stored or alternative storage location information for storing the food items for sale other than the recommended storage location.

A method of providing shopping information and a refrigerator to which the method is applied, according to the disclosure, may automatically provide information about currently stored food items or a food item required to be purchased to a user who wants to shop for a food item without a separate operation, thereby preventing redundant purchase or omission of purchase.

In addition, the method for providing shopping information and the refrigerator to which the method is applied, according to the disclosure, may determine a food category related to a store or a display stand where the user is currently located, and provide customized information related to the food category, thereby efficiently providing shopping information according to movements of the user.

A method according to an embodiment of the disclosure may be implemented in the form of program commands that may be executed by using various computer and recorded on a computer-readable medium. The computer-readable medium may include a program command, a data file, a data structure, and the like independently or collectively. The program commands recorded on the medium may be specially designed and configured for the disclosure or may be known and available to one of ordinary skill in the computer software field. Examples of computer-readable recording medium include magnetic media, such as hard disks, floppy disks, and magnetic tapes, optical media, such as compact disc read only memories (CD-ROMs) and digital versatile discs (DVDs), magneto-optical media, such as floptical disks, and hardware devices specially configured to store and execute program commands, such as read-only memory (ROM), random-access memory (RAM), and flash memory. Examples of the program command include not only machine codes generated by a compiler, but also high-level language codes that may be executed by a computer by using an interpreter or the like.

Some embodiments of the disclosure may also be implemented in the form of a recording medium including instructions executable by a computer, such as a program module executed by a computer. Computer-readable media may be any available media accessible by a computer and include all volatile and non-volatile media and separable and non-separable media. In addition, the computer-readable media may include all computer storage media and communication media. Computer storage media include all volatile and non-volatile media and separable and non-separable media implemented in any method or technology for storage of information, such as computer-readable instructions, data structures, program modules, and other data. Communication media typically include computer-readable instructions, data structures, program modules, other data of modulated data signals, such as carrier waves, or other transmission mechanisms, and include any information delivery media. In addition, some embodiments of the disclosure may be implemented as a computer program product or a computer program including computer-executable instructions, such as a computer-executable computer program.

A machine-readable storage medium may be provided in the form of a non-transitory storage medium. Here, the “non-transitory storage medium” only denotes a tangible device and does not contain a signal (for example, electromagnetic waves). This term does not distinguish a case where data is stored in the storage medium semi-permanently and a case where the data is stored in the storage medium temporarily. For example, the “non-transitory storage medium” may include a buffer in which data is temporarily stored.

According to an embodiment of the disclosure, a method according to various embodiments of the disclosure disclosed in the specification may be provided by being included in a computer program product. The computer program product may be traded between a seller and a buyer as a commodity. The computer program product may be distributed in the form of a machine-readable storage medium (e.g., compact disc read only memory (CD-ROM)), or may be distributed (e.g., downloaded or uploaded) through an application store or directly or online between two user devices (e.g., smartphones). In the case of online distribution, at least a portion of a computer program product (e.g., a downloadable application) may be at least temporarily generated or temporarily stored in a machine-readable storage medium, such as a server of a manufacturer, a server of an application store, or memory of a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of providing shopping information, the method comprising:
identifying a category of food items for sale in a store;
generating shopping information related to stored food items included in the identified category from among at least one food item stored in a refrigerator; and
transmitting the generated shopping information to a user terminal,
wherein the shopping information comprises at least one of a list of the stored food items, locations of the stored food items, an internal image of the refrigerator displaying the stored food items, a requirement list requiring purchase in the category, recipe information related to the food items for sale and the stored food items, and recommended storage location information related to where the food items for sale are to be stored in the refrigerator.

2. The method of claim 1, further comprising:
identifying, by the user terminal, that a user has entered the store by using location information and map information.

3. The method of claim 1, further comprising:
obtaining, by the refrigerator, the internal image of the refrigerator by photographing inside of the refrigerator and the at least one food item stocked in and taken out of the refrigerator by using at least one camera of the refrigerator.

4. The method of claim 1, wherein the identifying of the category comprises:
obtaining, by the user terminal, at least one piece of information from among location information of the user, information related to displayed food items, and information related to a display stand where the displayed food items are arranged; and
identifying the category based on the obtained at least one piece of information.

5. The method of claim 4, wherein the generating of the shopping information comprises:
requesting, by the user terminal, the internal image corresponding to the category;
identifying whether the stored food items are stored and storage locations of the stored food items;
obtaining the internal image including the storage locations; and
transmitting the internal image to the user terminal.

6. The method of claim 5, further comprising:
based on the stored food items corresponding to the category not being present in the refrigerator, transmitting, to the user terminal information indicating that the stored food items are not present and an entire internal image of the refrigerator.

7. The method of claim 1, wherein the generating of the shopping information comprises:
requesting, by the user terminal, the refrigerator for the requirement list requiring the purchase corresponding to the category;
determining whether purchase of the food items for sale is required; and
transmitting the requirement list to the user terminal.

8. The method of claim 1, wherein the generating of the shopping information comprises:
requesting, by the user terminal, the refrigerator for the recipe information corresponding to the category;
determining a recommended recipe related to the stored food items and the food items for sale; and
transmitting the recipe information to the user terminal.

9. The method of claim 1, wherein the generating of the shopping information comprises:
requesting, by the user terminal, the refrigerator for the recommended storage location information corresponding to the category;
identifying whether the food items for sale are storable in a recommended storage location corresponding to the category; and
transmitting, to the user terminal, the recommended storage location information including the recommended storage location.

10. The method of claim 9, further comprising:
based on the food items for sale being unable to be stored at the recommended storage location in the refrigerator, transmitting, by the refrigerator to the user terminal, guide information indicating that the food items for sale are unable to be stored or alternative storage location information for storing the food items for sale other than the recommended storage location.

11. A refrigerator comprising:
a communication module;
at least one camera;
memory, comprising one or more storage media, storing instructions; and
at least one processor communicatively coupled to the communication module, the at least one camera, and the memory,
wherein the instructions, when executed by the at least one processor individually or collectively, cause the refrigerator to:
receive, from a user terminal, a result of identifying a category of food items for sale in a store,
generate shopping information related to stored food items included in the identified category from among at least one stored food item, and
transmit the generated shopping information to the user terminal, and
wherein the shopping information comprises at least one of a list of the stored food items, locations of the stored food items, an internal image displaying the stored food items, a requirement list requiring purchase in the category, recipe information related to the food items for sale and the stored food items, and recommended storage location information related to where the food items for sale are to be stored.

12. The refrigerator of claim 11, wherein the instructions, when executed by the at least one processor individually or collectively, further cause the refrigerator to:
receive a result of identifying, by the user terminal, that a user has entered the store by using location information and map information.

13. The refrigerator of claim 12, wherein the instructions, when executed by the at least one processor individually or collectively, further cause the refrigerator to:
obtain the internal image of the refrigerator by photographing inside of the refrigerator and at least one food item stocked in and taken out of the refrigerator by using the at least one camera.

14. The refrigerator of claim 13, wherein the instructions, when executed by the at least one processor individually or collectively, further cause the refrigerator to:
receive at least one piece of information obtained by the user terminal from among location information of the user, information related to displayed food items, and information related to a display stand where the displayed food items are arranged, and
identify the category based on the obtained at least one piece of information.

15. The refrigerator of claim 14, wherein the instructions, when executed by the at least one processor individually or collectively, further cause the refrigerator to:
receive, from the user terminal, a signal requesting the internal image corresponding to the category,
identify whether the stored food items are stored and storage locations of the stored food items,
obtain the internal image including the storage locations, and
transmit the internal image to the user terminal.

16. The refrigerator of claim 15, wherein the instructions, when executed by the at least one processor individually or collectively, further cause the refrigerator to:
based on the stored food items corresponding to the category not being present in the refrigerator, transmit, to the user terminal information indicating that the stored food items are not present and an entire internal image of the refrigerator.

17. The refrigerator of claim 15, wherein the instructions, when executed by the at least one processor individually or collectively, further cause the refrigerator to:
receive a request for the requirement list requiring the purchase corresponding to the category,
determine whether purchase of the food items for sale is required, and
transmit the requirement list to the user terminal.

18. The refrigerator of claim 15, wherein the instructions, when executed by the at least one processor individually or collectively, further cause the refrigerator to:
receive a request for the recipe information corresponding to the category,
determine a recommended recipe related to the stored food items and the food items for sale, and
transmit the recipe information to a user terminal.

19. One or more non-transitory computer-readable storage media storing one or more computer programs including computer-executable instructions that, when executed by at least one processor of a refrigerator, cause the refrigerator to perform operations, the operations comprising:
receiving a result of identifying a category of food items for sale in a store;
generating shopping information related to stored food items included in the identified category from among at least one food item stored in the refrigerator; and
transmitting the generated shopping information to a user terminal,
wherein the shopping information comprises at least one of a list of the stored food items, locations of the stored food items, an internal image of the refrigerator displaying the stored food items, a requirement list requiring purchase in the category, recipe information related to the food items for sale and the stored food items, and recommended storage location information related to where the food items for sale are to be stored in the refrigerator.

20. The one or more non-transitory computer-readable storage media of claim 19, the operations further comprising:
receiving a result of identifying, by the user terminal, that a user has entered the store by using location information and map information.
